(19) United States
(12) Patent Application Publication
(10) Pub. No.: US 2026/0341159 A1
(43) Pub. Date: Oct. 29, 2026

(54) ADAPTIVE SYSTEMS AND METHODS FOR FIXED-BASE OPERATOR AVIATION SERVICES WITH GEOSPATIAL INSPECTION VALIDATION AND DYNAMIC WORKFLOW OPTIMIZATION

(71) Applicant: Gregory M. Griffith, Holland, MI (US)

(72) Inventor: Gregory M. Griffith, Holland, MI (US)

(21) Appl. No.: 19/732,847

(22) Filed: Jul. 7, 2026

Related U.S. Application Data
(63) Continuation-in-part of application No. 19/274,804, filed on Jul. 21, 2025.
Application No. 19/274,804 is a continuation of application No. 17/693,625, filed on Mar. 14, 2022, now Pat. No. 12,374,228.

(51) Int. Cl. G08G 5/26; B64F 5/40; G06Q 10/0631; G08G 5/22; G08G 5/56

(52) U.S. Cl. CPC G08G 5/26; B64F 5/40; G08G 5/22; G08G 5/56; G06Q 10/063114

(57) ABSTRACT

An adaptive system and method for conducting fixed-base operator aviation services using a portable electronic device. The system includes a geospatial verification module that determines the position of the portable device relative to an aircraft and selectively enables completion of inspection checkpoints based on proximity to checkpoint locations. An adaptive workflow engine dynamically generates inspection checklists based on contextual factors including aircraft type, inspection history, weather conditions, and operational constraints. The system enforces progressive disclosure of checkpoints, requiring completion of each checkpoint with a condition assessment and photograph before revealing subsequent checkpoints. Historical photographs from prior inspections of the same aircraft are displayed for comparative analysis. An audit module records device traversal paths and checkpoint interaction timestamps for supervisory review. The system transforms paper-based FBO inspection workflows into validated digital records with geospatial verification of inspector presence at each checkpoint location.

### CROSS-REFERENCE TO RELATED APPLICATIONS

This application is a continuation-in-part of U.S. application Ser. No. 19/274,804, entitled “SYSTEMS AND METHODS FOR CONDUCTING FIXED-BASE OPERATOR (FBO) AVIATION SERVICES USING A PORTABLE ELECTRONIC DEVICE,” filed Jul. 21, 2025, which is a continuation of U.S. application Ser. No. 17/693,625, entitled “SYSTEMS AND METHODS FOR CONDUCTING FIXED-BASE OPERATOR (FBO) AVIATION SERVICES USING A PORTABLE ELECTRONIC DEVICE,” filed Mar. 14, 2022, now U.S. Pat. No. 12,374,228—all of which are hereby incorporated herein by reference in their entirety, including all references cited therein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

### 1. Field of the Invention

The present invention relates generally to systems and methods for conducting fixed-base operator (FBO) aviation services using portable electronic devices and, more particularly, to adaptive platforms that enable FBO personnel to perform aircraft arrival, departure, inspection, maintenance, fueling, towing, parking, hangaring, and repositioning services while validating compliance with standard operating procedures through geospatial verification and real-time data capture. The invention further relates to systems that dynamically adjust inspection workflows based on contextual factors including inspector location, aircraft history, environmental conditions, and operational constraints. The invention still further relates to methods of transforming paper-based FBO operations into validated digital records that establish verifiable chains of custody, ensure inspection integrity, and optimize operational efficiency through adaptive workflow management.

### 2. Description of the Related Art

Fixed-base operators, commonly known as FBOs, serve as the essential ground-side infrastructure of general aviation. Operating at airports throughout the world, FBOs provide the critical services that keep aircraft flying safely and efficiently. When a private jet lands at an airport, it is the FBO that marshals the aircraft to its parking position, inspects its exterior for damage or safety concerns, coordinates fueling operations, arranges for passenger ground transportation, and prepares the aircraft for its next departure. FBOs serve aircraft ranging from single-engine propeller planes to large intercontinental business jets, handling everything from routine fuel stops to extended maintenance layovers. The scope of FBO services encompasses aircraft arrival and departure handling, pre-flight and post-flight inspections, fueling, towing, parking, hangaring, repositioning, lavatory service, potable water replenishment, de-icing, and numerous other specialized aviation services.

The services performed by FBO personnel carry significant safety and liability implications. An improperly conducted inspection may fail to identify damage that compromises airworthiness. A fueling error may result in contaminated fuel entering aircraft tanks or incorrect fuel quantities being loaded. A towing mishap may cause damage to landing gear, wingtips, or other critical aircraft structures. These failures can result in catastrophic consequences including aircraft accidents, passenger injuries, and loss of life. Beyond safety considerations, FBO operations involve substantial financial exposure. Aircraft under FBO care may be valued at tens of millions of dollars, and damage occurring during ground handling can result in extensive liability claims, insurance disputes, and reputational harm to the FBO.

Given these safety and financial stakes, one might expect FBO operations to employ sophisticated systems for documenting services performed, verifying compliance with established procedures, and maintaining defensible records of aircraft condition. The reality of current industry practice, however, stands in stark contrast to this expectation. Despite operating in an era of ubiquitous computing and mobile connectivity, the vast majority of FBO operations continue to rely on paper-based documentation systems that have remained fundamentally unchanged for decades.

A typical FBO inspection workflow proceeds as follows. A line service technician retrieves a paper checklist from a clipboard or prints a form from an office computer. The technician walks to the aircraft and proceeds around its exterior, ostensibly examining each item listed on the checklist. As the technician completes each checkpoint, he or she marks a checkbox, circles a condition indicator, or writes brief notes on the paper form. Upon completing the inspection, the technician signs and dates the form, returns it to the FBO office, and the paper is filed in a folder or binder associated with that aircraft visit. This paper record then sits in a filing cabinet, rarely if ever reviewed unless a dispute arises regarding aircraft condition or services rendered.

This paper-based approach suffers from numerous deficiencies that undermine its intended purpose of documenting aircraft condition and validating service compliance. First and most fundamentally, paper checklists provide no verification that the inspector actually performed the inspection as documented. A technician may complete an entire checklist while standing in the break room, checking boxes for items never actually examined. The paper form cannot distinguish between a thorough inspection conducted over thirty minutes and a fabricated record created in thirty seconds. There exists no mechanism to confirm the technician's physical presence at each inspection point, no timestamp granularity beyond the single date and time written on the form, and no objective evidence that any particular checkpoint was actually observed.

Second, paper documentation provides no quality control over the data recorded. A technician may mark an item as satisfactory without meaningful observation, may fail to notice developing damage that a comparative review of historical photographs would reveal, or may simply lack the training to recognize certain defect conditions. The paper form accepts whatever the technician writes without validation, verification, or intelligent prompting. If a technician skips a checkpoint entirely, whether through oversight or intentional omission, the paper system provides no alert, no escalation, and no record of the omission.

Third, paper records are inherently difficult to search, aggregate, and analyze. If an FBO wishes to determine how many times a particular aircraft has visited over the past year, what conditions were noted during those visits, or whether a pattern of recurring issues exists, the answer lies buried in hundreds of paper forms that must be manually retrieved and reviewed. Identifying trends across an entire fleet of similar aircraft—for example, recognizing that a particular aircraft model exhibits elevated rates of a specific maintenance issue—is practically impossible when the underlying data exists only as handwritten marks on paper stored in filing cabinets. The wealth of operational intelligence that could be derived from systematic analysis of inspection data remains locked in an inaccessible format.

Fourth, paper documentation creates significant evidentiary vulnerabilities in the event of disputes. When an aircraft owner claims that damage occurred while the aircraft was under FBO care, the FBO's defense rests upon the paper inspection forms documenting aircraft condition at arrival and departure. Yet these paper forms are easily challenged as unreliable, fabricated, or incomplete. The forms bear no objective verification of when they were actually completed, whether the recorded observations were actually made, or whether the technician was even present at the aircraft. Sophisticated aircraft owners and their insurers have become increasingly adept at attacking the credibility of paper FBO records, leaving FBOs exposed to liability for damage they may not have caused.

Fifth, paper-based systems impede operational efficiency. Supervisors cannot monitor inspection progress in real time, cannot identify bottlenecks or delays as they develop, and cannot dynamically reallocate resources to meet changing operational demands. When an aircraft's departure time approaches and its inspection remains incomplete, the paper system provides no warning until a crew member physically inquires about the aircraft's status. The disconnect between frontline operations and management oversight creates inefficiencies, delays, and customer service failures that erode FBO competitiveness.

The aviation industry has witnessed various attempts to digitize ground handling documentation, yet these efforts have largely failed to address the fundamental deficiencies of paper-based systems. Generic inspection software applications allow technicians to complete digital checklists on tablet computers or smartphones, replacing paper forms with electronic forms. While such applications may improve legibility and enable electronic storage, they do not solve the core verification problem. A technician can complete a digital checklist while sitting in an air-conditioned office just as easily as a paper checklist. The mere digitization of a form does not establish that an inspection was actually performed, does not verify the technician's presence at the aircraft, and does not validate the accuracy or completeness of the recorded observations.

Other digital approaches have focused on specific aspects of FBO operations without providing an integrated platform for comprehensive service documentation. Flight tracking systems monitor aircraft movements but do not document ground handling services. Fuel management systems record fuel transactions but do not capture inspection data. Maintenance tracking software manages scheduled maintenance items but does not address the ad hoc observations made during line service inspections. The fragmented nature of these point solutions leaves FBOs without a unified system for documenting the full scope of services performed and aircraft conditions observed.

Some digital documentation systems have incorporated location awareness through GPS tagging of inspection records, associating geographic coordinates with completed inspection forms. While such location tagging may confirm that a document was created or modified at a particular airport or general facility location, this approach fails to address the checkpoint-level verification that meaningful inspection validation requires. Knowing that an inspector's device was located somewhere on a large airport property when a form was completed provides no assurance that the inspector was actually positioned at the nose wheel when documenting nose wheel condition, at the left wingtip when documenting left wingtip condition, or at any other specific checkpoint. The granularity of facility-level or aircraft-level location tagging is wholly insufficient to validate that an inspector physically traversed the required inspection path and observed each checkpoint from the appropriate vantage point. An inspector standing fifty feet from an aircraft could complete a GPS-tagged digital form that would appear legitimate despite never having approached the aircraft closely enough to observe the inspection points documented therein.

What is needed, and what the prior art has failed to provide, is an adaptive platform purpose-built for FBO aviation services that transforms the inspection and documentation process from a passive recording exercise into an active validation system. Such a platform must verify that inspectors are physically present at required inspection points before allowing checkpoint completion. It must adapt its workflows dynamically based on contextual factors including the specific aircraft being serviced, its inspection history, current environmental conditions, and operational time constraints. It must capture objective evidence including photographs, videos, and audio recordings that corroborate the inspector's observations. It must enable real-time supervisory oversight and intelligent escalation of anomalies. It must aggregate data across inspections, aircraft, and time periods to reveal patterns and trends invisible in paper records. And it must create defensible digital records that can withstand scrutiny in disputes over aircraft condition and service performance.

The present invention addresses these needs through an adaptive fixed-base operator aviation services platform that leverages the geospatial capabilities, imaging sensors, and wireless connectivity of modern portable electronic devices to revolutionize how FBO services are documented, validated, and optimized.

These and other objects of the present invention will become apparent in light of the present specification, claims, and drawings.

### SUMMARY OF THE INVENTION

The following presents a simplified summary in order to provide a basic understanding of some aspects of the claimed subject matter. This summary is not an extensive overview and is not intended to identify key or critical elements or to delineate the scope of the claimed subject matter. Its purpose is to present certain concepts in a simplified form as a prelude to the more detailed description that is presented later.

In one aspect, the present invention provides an adaptive system for conducting fixed-base operator aviation services, the system comprising: (a) a portable electronic device comprising a processor, a memory, a display, a camera, a GPS receiver, and a wireless communication module; (b) a server in wireless communication with the portable electronic device, the server comprising a database storing aircraft records, inspection records, and standard operating procedures; (c) an adaptive workflow engine executing on at least one of the portable electronic device and the server, the adaptive workflow engine configured to dynamically generate an inspection checklist based on contextual factors associated with an aircraft to be inspected; and (d) a geospatial verification module configured to determine a position of the portable electronic device relative to a position of the aircraft and to selectively enable completion of inspection checkpoints based on the determined position.

The geospatial verification module may define a plurality of checkpoint zones corresponding to physical locations around the aircraft, enabling completion of a checkpoint only when the portable electronic device is positioned within the checkpoint zone corresponding to that checkpoint. The checkpoint zones may be defined as radial distances from predefined coordinates associated with specific aircraft components such as the nose wheel, left wingtip, tail section, right wingtip, and engine nacelles. The system may employ device compass orientation in conjunction with GPS position to verify that the inspector is facing the correct direction when documenting a checkpoint.

A progressive disclosure module may be configured to sequentially reveal inspection checkpoints on the display, wherein a subsequent checkpoint is revealed only upon completion of a preceding checkpoint. Completion of a checkpoint requires at least a condition assessment and a captured photograph, ensuring that inspectors cannot batch-complete multiple checkpoints without traversing to each location. This enforced sequential workflow prevents the “rubber stamping” behavior that undermines paper-based inspection systems.

The adaptive workflow engine generates inspection checklists based on contextual factors including aircraft type, aircraft inspection history, parking duration, weather conditions during parking, applicable service bulletins, owner-specific requirements, and time elapsed since the aircraft's last inspection. Extended parking duration may trigger additional checkpoints for wildlife intrusion and tire flat-spotting. Rain during parking may add water intrusion checkpoints. Known service bulletins for the aircraft model may append bulletin-specific inspection items. Previous inspections that identified caution conditions may require re-inspection of those items even when not otherwise scheduled.

The system may further comprise a comparative analysis module configured to retrieve a historical photograph of a checkpoint from a prior inspection of the same aircraft and to display the historical photograph adjacent to a current camera view during inspection of that checkpoint. This side-by-side comparative display enables inspectors to identify progressive damage such as scratches that have lengthened, corrosion that has spread, or wear patterns that have developed since the prior inspection. The comparative analysis module may provide controls for toggling between overlaid and side-by-side views and for accessing older historical photographs from the inspection archive.

A scheduling optimization module may prioritize inspection checkpoints based on a scheduled departure time of the aircraft. When available time before departure falls below a threshold, safety-critical checkpoints are prioritized to ensure essential items are completed even if the full inspection scope cannot be achieved. The scheduling optimization module may interface with flight operations systems to retrieve departure schedule data and may alert supervisory personnel when an inspection is unlikely to complete before the scheduled departure.

An audit module records the traversal path of the portable electronic device during inspection using GPS breadcrumb tracking and logs timestamps associated with each checkpoint interaction. The audit module enables reconstruction of the inspection sequence for supervisory review, displaying a map of inspector movement around the aircraft alongside a timeline of checkpoint completions. Anomalies such as checkpoints completed in unusually short time periods or extended periods of device immobility may be flagged for quality assurance review.

Photo quality validation ensures that captured checkpoint photographs meet minimum quality standards before acceptance. The system analyzes captured images for sufficient lighting, acceptable focus sharpness, correct camera orientation, and presence of expected checkpoint features. Photographs that fail quality validation trigger prompts for recapture with specific guidance such as “photograph too dark—enable flash or move to better lighting.”

When an inspector is unable to complete a checkpoint, the system requires structured justification through a predefined reason interface. Selectable reasons may include access blocked by equipment, safety hazard present, required tool unavailable, component not accessible on aircraft configuration, and an “other” option requiring accompanying text entry. Selection of an unable-to-complete status triggers automatic notification to supervisory personnel, creating accountability for omitted checkpoints and enabling timely resolution.

Certain safety-critical checkpoints may require dual inspector verification, wherein two different authenticated inspectors must independently assess the checkpoint. When assessments differ between inspectors, the system triggers automatic escalation requiring supervisory resolution before final status determination. This dual verification approach provides redundancy for high-consequence inspection items such as landing gear, control surfaces, and fuel system components.

The system may incorporate cross-fleet pattern detection that aggregates checkpoint data across multiple aircraft of the same make and model. Statistical analysis identifies anomalous failure rates for particular checkpoints, generating alerts when a checkpoint shows elevated caution or bad rates compared to historical baselines. Such pattern detection may reveal fleet-wide issues warranting service bulletin review or manufacturer notification.

A trend visualization feature displays the condition history for each checkpoint on a specific aircraft as a graphical indicator such as a sequence of colored dots representing the last several inspection results. This trend display enables immediate recognition of progressive deterioration patterns without requiring manual review of historical records.

Digital handoff acknowledgment creates verified chain of custody records as aircraft status changes between responsible parties. When an aircraft transitions from inspected to fueled, or from fueled to ready for departure, the receiving party must provide positive acknowledgment through the system. Each handoff creates a timestamped record identifying the acknowledging party, and alerts trigger when handoffs remain pending beyond threshold time periods.

Dynamic checkpoint sequencing optimizes the order of inspection checkpoints based on the inspector's current position relative to the aircraft. Rather than following a fixed sequence, the system calculates an optimal walking path through required checkpoints to minimize total traversal distance, accounting for aircraft orientation and re-optimizing when the inspector deviates from the suggested path.

The platform may incorporate advanced capabilities including artificial intelligence modules for predictive maintenance analysis, computer vision systems for automated damage detection, voice-activated inspection interfaces enabling hands-free operation, augmented reality guidance overlaying inspection instructions on the device camera view, blockchain-based maintenance records providing immutable audit trails, real-time collaboration features enabling remote expert consultation during inspections, automated parts ordering triggered by identified maintenance needs, weather-based scheduling intelligence that correlates environmental conditions with optimal inspection timing, locomotion-consistency verification that cross-validates reported device position against inertial sensor data to detect falsified position reports, photographic liveness verification and reference-feature-based dimensional quantification of documented conditions, and composite presence-confidence scoring that adaptively varies verification stringency in response to positioning signal quality.

In another aspect, the present invention provides a method of conducting fixed-base operator aviation services using a portable electronic device, comprising the steps of: (a) receiving an aircraft identifier at the portable electronic device; (b) determining, via a GPS receiver of the portable electronic device, a geographic position of an aircraft corresponding to the aircraft identifier; (c) generating, by an adaptive workflow engine, an inspection checklist dynamically tailored based on contextual factors associated with the aircraft; (d) displaying, on a display of the portable electronic device, a first inspection checkpoint of the inspection checklist; (e) determining, by a geospatial verification module, a position of the portable electronic device relative to the geographic position of the aircraft; (f) enabling data entry for the first inspection checkpoint only when the position of the portable electronic device is within a predefined proximity to a checkpoint location corresponding to the first inspection checkpoint; (g) receiving, via a user interface of the portable electronic device, a condition assessment for the first inspection checkpoint; (h) capturing, via a camera of the portable electronic device, a photograph associated with the first inspection checkpoint; and (i) transmitting the condition assessment and the photograph to a server for storage in association with the aircraft identifier.

The method may further comprise revealing subsequent inspection checkpoints only after receiving condition assessments and capturing photographs for preceding checkpoints. Generating the inspection checklist may comprise retrieving weather data, aircraft inspection history, parking duration, and service bulletin applicability, and modifying checkpoint content based on the retrieved data. Historical photographs from prior inspections may be retrieved and displayed simultaneously with live camera views to enable comparative assessment.

Captured photographs may be validated against quality criteria prior to acceptance, with recapture prompts issued when criteria are not satisfied. Unable-to-complete selections may require structured justification and trigger automatic supervisory notification. The inspection checklist may be dynamically reordered based on current device position to minimize traversal distance between checkpoints.

In yet another aspect, the present invention provides a non-transitory computer-readable medium storing instructions that, when executed by a processor of a portable electronic device, cause the portable electronic device to perform operations comprising: (a) receiving an aircraft identifier; (b) determining a geographic position of an aircraft corresponding to the aircraft identifier; (c) generating an adaptive inspection checklist based on contextual factors associated with the aircraft; (d) displaying inspection checkpoints on a display of the portable electronic device; (e) determining a position of the portable electronic device relative to the aircraft; (f) selectively enabling checkpoint completion based on the determined position satisfying a geospatial proximity requirement; (g) receiving condition assessments and capturing photographs for enabled checkpoints; and (h) transmitting inspection data to a remote server for storage.

The operations may further comprise sequentially revealing checkpoints such that subsequent checkpoints are displayed only upon completion of preceding checkpoints. Historical photographs from prior inspections of the same aircraft may be retrieved and displayed for comparative assessment. The contextual factors may comprise aircraft type, prior inspection findings, elapsed time since last inspection, weather exposure during parking, and applicable service bulletins. A GPS breadcrumb trail of device movement and checkpoint interaction timestamps may be recorded to enable audit reconstruction. Safety-critical checkpoints may be prioritized when a scheduled departure time is within a threshold period.

These and other aspects of the present invention will become more fully apparent from the following detailed description, the appended claims, and the accompanying drawings.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted. It will be further understood that the invention is not necessarily limited to the particular embodiments illustrated herein.

FIG. 1 is a system architecture diagram illustrating communication between a portable electronic device, a server, and various system modules according to an embodiment of the present invention.

FIG. 2 is a schematic diagram illustrating geospatial verification of inspector position relative to checkpoint zones defined around an aircraft according to an embodiment of the present invention.

FIG. 3 is a flowchart illustrating progressive disclosure of inspection checkpoints according to an embodiment of the present invention.

FIG. 4 is a representation of a comparative photo display showing a historical photograph adjacent to a current camera view according to an embodiment of the present invention.

FIG. 5 is a representation of an audit timeline view illustrating inspector traversal path and checkpoint interaction timestamps according to an embodiment of the present invention.

FIG. 6 is a flowchart illustrating a method of conducting fixed-base operator aviation services using a portable electronic device according to an embodiment of the present invention.

FIGS. 7.1-7.12 are representations of graphical user interface screens displayed on a portable electronic device during an inspection workflow according to an embodiment of the present invention.

FIG. 8 is a block diagram illustrating components of a computing system suitable for implementing embodiments of the present invention.

FIG. 9 is a block diagram illustrating enhanced dashboard and notification components of the graphical user interface according to an embodiment of the present invention.

FIG. 10 is a block diagram illustrating inspection interface components including checkpoint interaction elements and analysis and validation elements according to an embodiment of the present invention.

FIG. 11 is a block diagram illustrating digital handoff architecture including handoff acknowledgment and chain of custody record generation according to an embodiment of the present invention.

### REFERENCE NUMERALS

Reference numerals used throughout the detailed description and drawings correspond to the following elements:
10—adaptive system for conducting fixed-base operator aviation services
12—portable electronic device
14—processor
16—memory
18—display
20—camera
22—GPS receiver
24—wireless communication module
26—user interface
28—compass
30—server
32—database
34—aircraft records
36—inspection records
38—standard operating procedures
40—adaptive workflow engine
42—geospatial verification module
44—progressive disclosure module
46—comparative analysis module
48—scheduling optimization module
50—audit module
52—photo quality validation module
54—skip justification module
56—dual verification module
58—cross-fleet pattern detection module
60—trend visualization module
62—digital handoff module
64—dynamic sequencing module
66—aircraft
68—tail number
70—aircraft position
72—checkpoint zone
74—checkpoint location
76—inspection checklist
78—inspection checkpoint
80—condition assessment
82—photograph
84—historical photograph
86—traversal path
88—timestamp
90—notification
92—graphical user interface
94—dashboard screen
96—aircraft selection screen
98—inspection initiation screen
100—checkpoint display screen
102—condition selector
104—photo capture interface
106—audio note recorder
108—unable-to-complete interface
110—justification selector
112—comparative display screen
114—side-by-side view
116—overlay view
118—trend indicator
120—checkpoint history display
122—audit replay screen
124—traversal map
126—interaction timeline
128—supervisor alert
130—handoff acknowledgment screen
132—chain of custody record
134—departure schedule
136—priority indicator
138—quality validation prompt
140—recapture prompt
142—contextual factors
144—aircraft type
146—inspection history
148—parking duration
150—weather conditions
152—service bulletins
154—owner-specific requirements
156—computing system
158—system bus
160—storage device
162—network interface
164—input device
166—output device

### DETAILED DESCRIPTION OF THE INVENTION

### I. Preamble

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

### II. Definitions

It will be understood that when an element is referred to as being “on,” “attached to,” “connected to,” “coupled to,” “in communication with,” or the like with respect to another element, it can be directly on, attached to, connected to, coupled to, or in communication with the other element, or intervening elements may also be present. In contrast, when an element is referred to as being “directly on,” “directly attached to,” “directly connected to,” “directly coupled to,” or “directly in communication with” another element, there are no intervening elements present.

As used herein, the term “fixed-base operator” or “FBO” refers to a commercial enterprise granted the right by an airport to operate on the airport and provide aeronautical services to aircraft operators. FBO services include, but are not limited to, aircraft fueling, aircraft parking, aircraft hangaring, aircraft towing, aircraft repositioning, passenger handling, crew services, ground power, lavatory service, potable water service, de-icing, pre-flight inspection, post-flight inspection, arrival handling, and departure handling.

As used herein, the term “adaptive” refers to the capability of a system, method, or module to modify its behavior, output, or configuration in response to varying input conditions, contextual factors, or operational circumstances. An adaptive system dynamically adjusts its operation rather than following fixed, predetermined procedures regardless of context. In the context of the present invention, adaptive functionality includes generating inspection checklists based on aircraft-specific factors, reordering checkpoints based on inspector position, prioritizing items based on time constraints, and modifying workflows based on environmental conditions.

As used herein, the term “geospatial verification” refers to the process of determining a geographic position of a device or user and validating that position against predefined spatial criteria before permitting an action to occur. Geospatial verification employs positioning technologies including Global Positioning System (GPS), Global Navigation Satellite System (GNSS), assisted GPS (A-GPS), Wi-Fi positioning, Bluetooth beacons, or combinations thereof.

As used herein, the term “checkpoint zone” refers to a defined geographic area associated with an inspection checkpoint, wherein an inspector must be physically located to complete documentation for that checkpoint. A checkpoint zone may be defined as a radial distance from a point, a polygonal area, or other geometric boundary. Checkpoint zones are positioned relative to aircraft location such that each checkpoint zone corresponds to an area from which the associated aircraft component can be properly observed and inspected.

As used herein, the term “progressive disclosure” refers to a user interface design pattern in which information, options, or interface elements are revealed sequentially rather than presented simultaneously. In the context of the present invention, progressive disclosure requires completion of a current inspection checkpoint before revealing subsequent checkpoints, thereby enforcing sequential inspection workflow.

As used herein, the term “contextual factors” refers to data elements that influence adaptive system behavior, including but not limited to aircraft type, aircraft tail number, aircraft inspection history, parking duration, weather conditions, applicable service bulletins, owner-specific requirements, time since last inspection, scheduled departure time, and inspector credentials.

As used herein, the term “standard operating procedures” or “SOPs” refers to documented processes, protocols, and requirements governing the performance of FBO services. SOPs may be defined by the FBO, by aircraft owners or operators, by aircraft manufacturers, by regulatory authorities, or by industry organizations. SOPs may specify required inspection checkpoints, acceptable condition criteria, documentation requirements, and escalation procedures.

As used herein, the term “condition assessment” refers to an evaluation of the status of an inspection checkpoint, typically expressed as a categorical selection such as good, caution, or bad, or as a numerical rating, or as descriptive text. A condition assessment represents the inspector's documented observation of the checkpoint at the time of inspection.

As used herein, the term “chain of custody” refers to a documented sequence of transfers of responsibility for an aircraft or aircraft-related service between identified parties. Chain of custody records establish accountability by identifying who was responsible for an aircraft at each point in time and documenting acknowledgment of responsibility transfers.

As used herein, the term “portable electronic device” refers to a handheld or wearable computing device capable of wireless communication and comprising at least a processor, memory, display, and user input capability. Portable electronic devices include, but are not limited to, smartphones, tablet computers, ruggedized mobile computers, and wearable computing devices.

As used herein, the term “controller,” “processor,” or “computing device” refers to any device or system capable of executing instructions to perform specified functions, including but not limited to microprocessors, microcontrollers, digital signal processors, application-specific integrated circuits (ASICs), field-programmable gate arrays (FPGAs), and general-purpose computing hardware executing software instructions.

### III. System Architecture

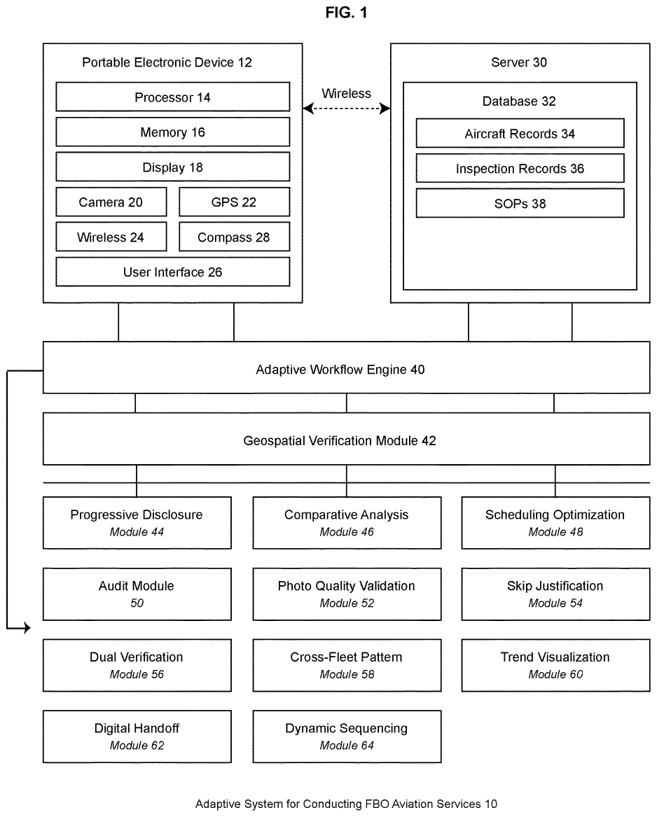

Referring now to FIGS. 1-11, an adaptive system 10 for conducting fixed-base operator aviation services according to an embodiment of the present invention is illustrated. The system 10 comprises a portable electronic device 12, a server 30, an adaptive workflow engine 40, and a geospatial verification module 42.

The portable electronic device 12 comprises a processor 14, a memory 16, a display 18, a camera 20, a GPS receiver 22, a wireless communication module 24, a user interface 26, and optionally a compass 28. The processor 14 executes instructions stored in the memory 16 to perform the operations described herein. The memory 16 may comprise volatile memory such as random access memory (RAM) and non-volatile memory such as flash memory or solid-state storage. The display 18 presents graphical user interface elements and information to the user and may comprise a liquid crystal display (LCD), organic light-emitting diode (OLED) display, or other display technology. The display 18 may incorporate touch-sensitive input capability enabling user interaction through touch gestures.

The camera 20 captures still photographs and video for documentation of inspection checkpoints. The camera 20 may comprise a rear-facing camera, a front-facing camera, or both. The camera 20 may include features such as autofocus, image stabilization, flash illumination, and high dynamic range (HDR) imaging. The GPS receiver 22 determines the geographic position of the portable electronic device 12 using signals from GPS satellites or other global navigation satellite systems. The GPS receiver 22 may employ assisted GPS (A-GPS) techniques utilizing network data to improve position fix time and accuracy.

The wireless communication module 24 enables communication between the portable electronic device 12 and the server 30, as well as communication with other devices and networks. The wireless communication module 24 may support cellular data communication (4G LTE, 5G), Wi-Fi (IEEE 802.11), Bluetooth, and other wireless protocols. The user interface 26 receives input from the user through touch input on the display 18, physical buttons, voice input via microphone, or other input modalities.

The compass 28, when present, determines the orientation of the portable electronic device 12 relative to magnetic north. Compass data may be combined with GPS position data to verify not only that an inspector is located at a checkpoint zone but also that the inspector is facing the correct direction to observe the associated aircraft component.

The server 30 is in wireless communication with the portable electronic device 12 via a network such as the Internet, a cellular data network, a private network, or a local area network. The server 30 comprises a database 32 storing aircraft records 34, inspection records 36, and standard operating procedures 38. The server 30 may comprise a single computing device, a plurality of computing devices, cloud-based computing resources, or a combination thereof.

Aircraft records 34 include information associated with specific aircraft identified by tail number 68, including aircraft type, aircraft make and model, aircraft owner, aircraft operator, aircraft configuration, and aircraft-specific inspection requirements. Inspection records 36 include historical documentation of inspections performed on aircraft, including timestamps, inspector identification, condition assessments 80, photographs 82, audio notes, and other inspection data. Standard operating procedures 38 include checkpoint definitions, inspection sequences, condition criteria, escalation rules, and other procedural requirements governing inspection performance.

The adaptive workflow engine 40 executes on at least one of the portable electronic device 12 and the server 30. In certain embodiments, the adaptive workflow engine 40 executes primarily on the server 30 with results communicated to the portable electronic device 12. In other embodiments, the adaptive workflow engine 40 executes primarily on the portable electronic device 12 with data synchronized to the server 30. In still other embodiments, the adaptive workflow engine 40 is distributed across both the portable electronic device 12 and the server 30. The adaptive workflow engine 40 is configured to dynamically generate an inspection checklist 76 based on contextual factors 142 associated with an aircraft 66 to be inspected.

The geospatial verification module 42 is configured to determine a position of the portable electronic device 12 relative to a position 70 of the aircraft 66 and to selectively enable completion of inspection checkpoints 78 based on the determined position. The geospatial verification module 42 may execute on the portable electronic device 12, on the server 30, or distributed across both.

### IV. Geospatial Verification

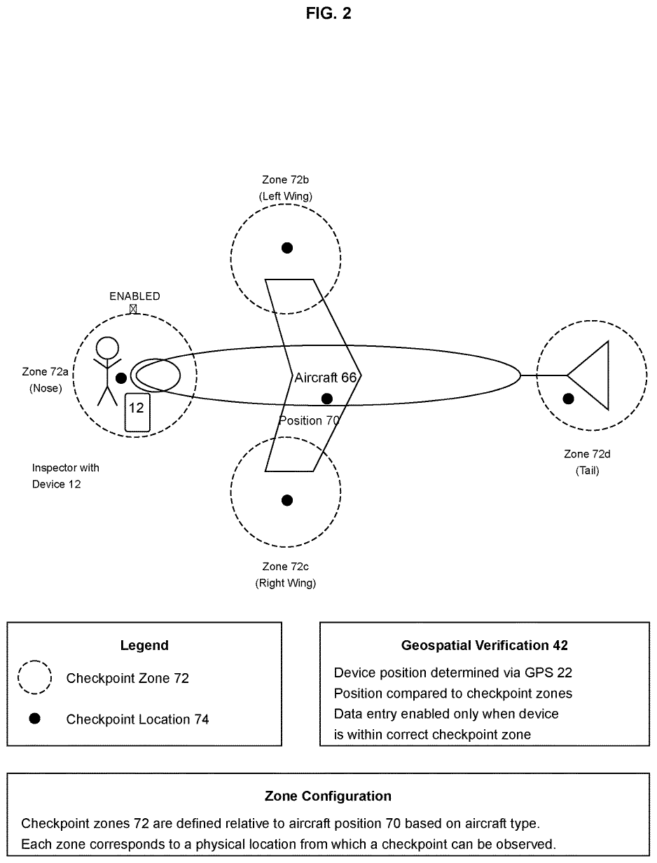

Referring now to FIG. 2, geospatial verification of inspector position relative to checkpoint zones 72 defined around an aircraft 66 is illustrated. The geospatial verification module 42 defines a plurality of checkpoint zones 72 corresponding to physical locations around the aircraft 66, illustrated in FIG. 2 as a nose checkpoint zone 72a, a left wing checkpoint zone 72b, a right wing checkpoint zone 72c, and a tail checkpoint zone 72d. Each checkpoint zone 72 is associated with a checkpoint location 74 representing a position from which a particular aircraft component or area can be properly observed and inspected.

When an inspector initiates inspection of an aircraft 66, the system 10 determines the aircraft position 70 using one or more techniques. The aircraft position 70 may be determined by GPS coordinates entered by the inspector, by GPS coordinates automatically captured when the inspector is proximate to the aircraft, by fixed coordinates associated with a parking position or hangar location, by data received from an aircraft transponder or ADS-B system, or by integration with airport ground movement tracking systems.

Based on the aircraft position 70 and the aircraft type, the geospatial verification module 42 generates checkpoint zones 72 positioned relative to the aircraft 66. For example, a nose wheel checkpoint zone may be defined as a circular area of predefined radius centered on coordinates offset from the aircraft position 70 by a distance corresponding to the location of the nose wheel for that aircraft type. Similarly, checkpoint zones 72 may be defined for left wingtip, right wingtip, tail section, engine nacelles, main landing gear, cockpit windows, fuselage inspection points, and other checkpoint locations 74 appropriate to the aircraft type and applicable SOPs.

The geospatial verification module 42 continuously or periodically determines the position of the portable electronic device 12 using the GPS receiver 22. The determined position is compared to the checkpoint zones 72 to identify which checkpoint zone 72, if any, contains the current device position. The geospatial verification module 42 enables completion of an inspection checkpoint 78 only when the portable electronic device 12 is positioned within the checkpoint zone 72 corresponding to that checkpoint.

When the portable electronic device 12 is not within any checkpoint zone 72, or is within a checkpoint zone 72 that does not correspond to the currently displayed checkpoint, the user interface presents the checkpoint information in a view-only mode with data entry disabled. Visual indication such as grayed-out controls, a lock icon, or an instructional message informs the inspector that the checkpoint cannot be completed from the current location. Upon the portable electronic device 12 entering the correct checkpoint zone 72, the user interface transitions to an enabled state permitting condition assessment entry and photograph capture.

The checkpoint zones 72 may be configured with various geometric definitions. Circular checkpoint zones are defined by a center point and radius. Polygonal checkpoint zones are defined by a series of vertices forming a closed polygon. Arc-shaped checkpoint zones may be appropriate for components that can be observed from a range of angles at a particular distance. The radius or size of checkpoint zones 72 may vary based on the nature of the checkpoint, with smaller zones for detailed inspection points and larger zones for general observation points.

In certain embodiments, the geospatial verification module 42 employs compass data from the compass 28 to verify inspector orientation in addition to position. For checkpoints requiring observation from a particular angle, the system may require both position within the checkpoint zone 72 and device orientation within an acceptable angular range relative to the aircraft component. This orientation verification ensures the inspector is facing the component being documented rather than facing away from it.

The geospatial verification module 42 may employ enhanced positioning technologies beyond GPS to improve accuracy in environments where GPS signals may be degraded. Bluetooth beacons positioned at known locations around the ramp or hangar area may provide supplemental positioning data through proximity detection and signal strength triangulation. Wi-Fi positioning using known access point locations may supplement GPS data. In certain embodiments, the system 10 may integrate with aircraft-mounted Bluetooth beacons that provide sub-meter positioning accuracy relative to specific aircraft components.

### V. Progressive Disclosure

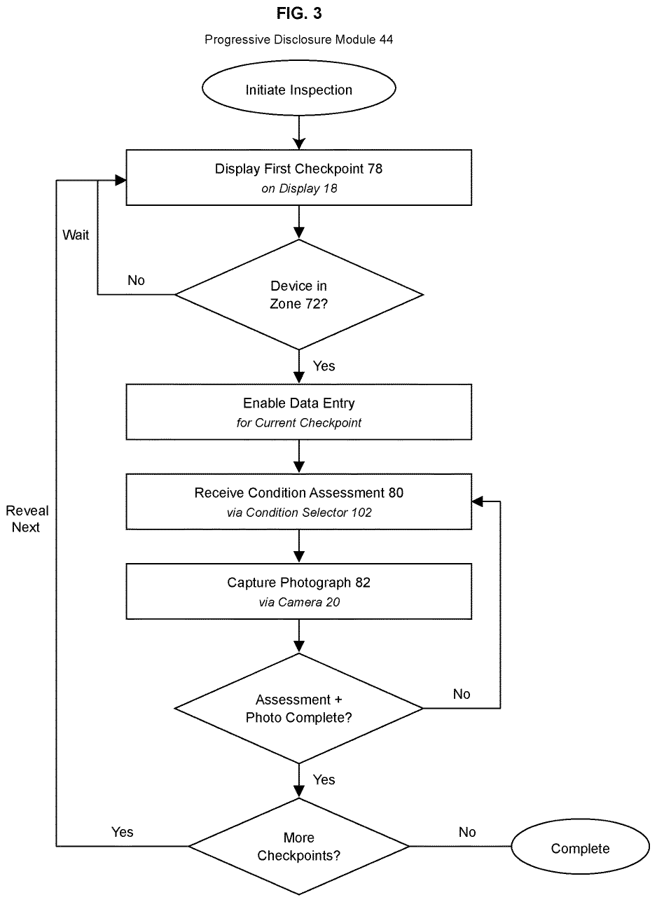

Referring now to FIG. 3, a flowchart illustrating progressive disclosure of inspection checkpoints 78 according to an embodiment of the present invention is shown. The system 10 comprises a progressive disclosure module 44 configured to sequentially reveal inspection checkpoints 78 on the display 18.

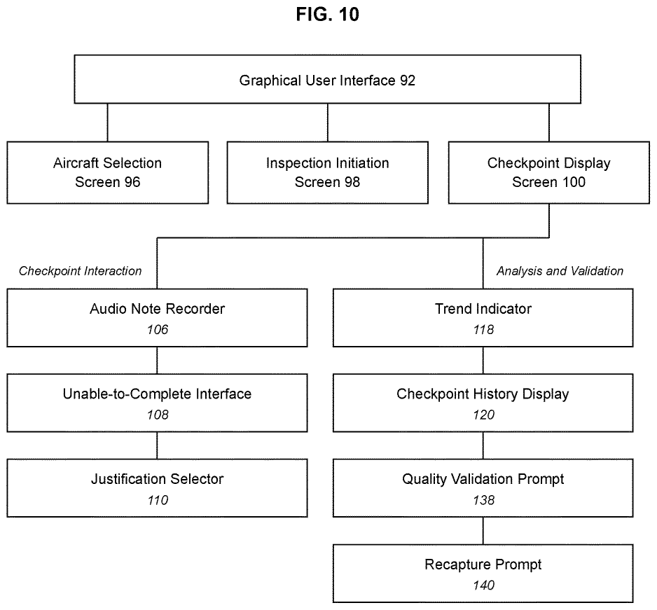

Upon initiation of an inspection, the progressive disclosure module 44 displays a first inspection checkpoint 78 on the display 18. The display presents checkpoint identification, inspection instructions, the condition selector 102, the photo capture interface 104, and optionally the audio note recorder 106 (FIG. 10). Subsequent checkpoints are not displayed and are not accessible to the inspector at this stage.

To complete the first checkpoint, the inspector must provide at least a condition assessment 80 via the condition selector 102 and capture a photograph 82 via the photo capture interface 104. The condition selector 102 may present options such as “Good,” “Caution,” and “Bad,” or numerical ratings, or other assessment scales defined by applicable SOPs. The inspector selects the condition assessment 80 reflecting the observed state of the checkpoint component.

The photo capture interface 104 activates the camera 20 and displays a viewfinder enabling the inspector to frame and capture a photograph 82 of the checkpoint component. The photograph 82 is associated with the checkpoint and stored as part of the inspection record. In certain embodiments, multiple photographs may be captured for a single checkpoint.

Upon receipt of both the condition assessment 80 and at least one photograph 82 for the current checkpoint, the progressive disclosure module 44 reveals the next inspection checkpoint 78 in the sequence. The previously completed checkpoint may be collapsed, hidden, or displayed in a completed state, while the newly revealed checkpoint becomes the active checkpoint for inspector attention.

This progressive disclosure approach prevents batch completion of checkpoints. An inspector cannot complete multiple checkpoints simultaneously or complete checkpoints out of sequence without physically traversing to each checkpoint location (enforced by geospatial verification) and providing the required documentation. The combination of progressive disclosure and geospatial verification ensures that inspection records reflect actual sequential inspection of each checkpoint from the appropriate physical location.

In certain embodiments, the progressive disclosure module 44 permits limited non-sequential access under defined circumstances. An inspector may be permitted to revisit a previously completed checkpoint to add additional photographs or notes, or to revise a condition assessment if an error was made. However, forward progression to new checkpoints requires completion of all preceding checkpoints.

In certain embodiments, the progressive disclosure module 44 accommodates checkpoints that may be completed in variable order within a defined group. For example, all checkpoints on the left side of an aircraft may be completable in any order relative to each other, but all left-side checkpoints must be completed before right-side checkpoints become available. This grouped progressive disclosure balances enforcement of inspection discipline with practical flexibility for inspector workflow.

### VI. Adaptive Workflow Engine

The adaptive workflow engine 40 generates inspection checklists 76 dynamically based on contextual factors 142 associated with the aircraft 66 to be inspected. Unlike static checklists that present identical checkpoints regardless of circumstances, the adaptive workflow engine 40 tailors the inspection checklist 76 to the specific aircraft, its history, current conditions, and operational context.

Contextual factors 142 influencing checklist generation include aircraft type 144, inspection history 146, parking duration 148, weather conditions 150, service bulletins 152, and owner-specific requirements 154. The adaptive workflow engine 40 retrieves relevant contextual factors 142 from the database 32, from external data sources, and from inspector input, and applies rules, algorithms, or machine learning models to generate an appropriate inspection checklist 76.

Aircraft type 144 determines the baseline set of checkpoints appropriate for the aircraft make and model. Different aircraft types have different configurations, different critical inspection points, and different SOP requirements. A large-cabin business jet requires different checkpoints than a single-engine turboprop. The adaptive workflow engine 40 maintains checkpoint templates for various aircraft types and selects the appropriate template based on the aircraft type 144 identified from the aircraft records 34.

Inspection history 146 influences checklist generation by identifying items warranting special attention based on prior findings. If a previous inspection of the same aircraft identified a caution condition at a particular checkpoint, the adaptive workflow engine 40 may flag that checkpoint for enhanced scrutiny, require additional documentation, or add supplemental inspection items. Recurring issues across multiple inspections may trigger escalated inspection requirements or maintenance recommendations.

Parking duration 148 affects checklist content by adding checkpoints appropriate for aircraft that have been stationary for extended periods. An aircraft parked for several days may require inspection for wildlife intrusion, insect nesting in pitot tubes or static ports, tire flat-spotting, accumulation of debris, or other conditions that develop during extended ground time. The adaptive workflow engine 40 calculates parking duration from aircraft arrival records and adds duration-appropriate checkpoints when thresholds are exceeded.

Weather conditions 150 during the parking period influence checklist generation by adding weather-related checkpoints. If rain occurred while the aircraft was parked, the adaptive workflow engine 40 may add checkpoints for water intrusion in baggage compartments, water accumulation in control surface cavities, or water contamination in fuel tanks. If high winds occurred, checkpoints for debris impact damage may be added. If freezing conditions occurred, checkpoints for ice accumulation or frost may be added. Weather data may be retrieved from airport weather systems, national weather services, or commercial weather data providers.

Service bulletins 152 applicable to the aircraft type and registration may require specific inspection items beyond standard checkpoints. The adaptive workflow engine 40 may access service bulletin databases maintained by aircraft manufacturers, regulatory authorities, or industry organizations, and add bulletin-specific checkpoints when applicable bulletins are identified. This ensures that known issues affecting particular aircraft types or serial number ranges are addressed during inspections.

Owner-specific requirements 154 enable customization of inspection checklists based on preferences or requirements of the aircraft owner or operator. Some owners may require additional checkpoints beyond standard SOPs, may specify particular documentation requirements, or may designate certain items as critical. The adaptive workflow engine 40 retrieves owner-specific requirements 154 from the aircraft records 34 and incorporates them into the generated checklist.

### VII. Comparative Analysis

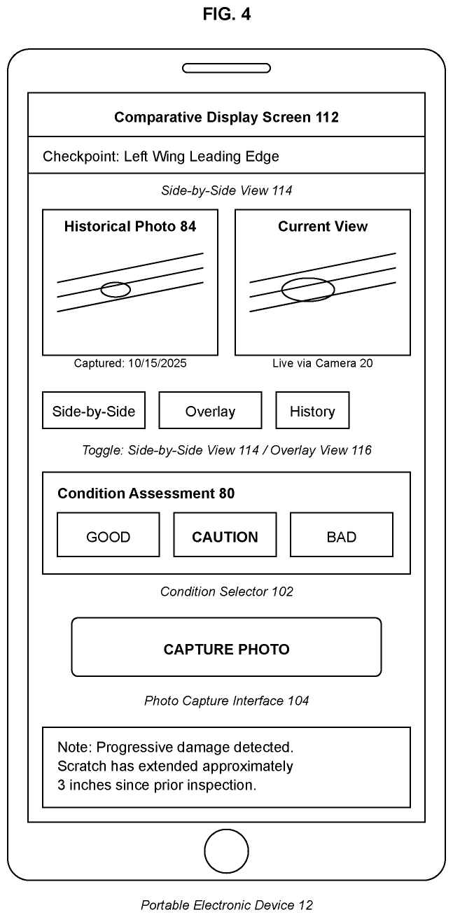

Referring now to FIG. 4, a comparative photo display showing a historical photograph 84 adjacent to a current camera view according to an embodiment of the present invention is illustrated. The system 10 comprises a comparative analysis module 46 configured to retrieve historical photographs 84 from prior inspections of the same aircraft 66 and to display them for comparison during current inspection.

When an inspector is documenting a checkpoint, the comparative analysis module 46 queries the inspection records 36 in the database 32 to identify prior inspections of the same aircraft 66 identified by tail number 68. The query retrieves historical photographs 84 captured at the same checkpoint during previous inspections. The most recent historical photograph 84 is displayed on the comparative display screen 112 adjacent to the current camera view from the photo capture interface 104.

The comparative display screen 112 presents a side-by-side view 114 with the historical photograph 84 on one portion of the display 18 and the live camera view on another portion. This arrangement enables the inspector to directly compare the current state of the checkpoint component with its documented state at the prior inspection. Changes such as new scratches, spreading corrosion, increased wear, developing cracks, or accumulating contamination become visually apparent through this comparison.

In certain embodiments, the comparative display screen 112 provides an overlay view 116 as an alternative to the side-by-side view 114. In the overlay view 116, the historical photograph 84 is superimposed on the current camera view with adjustable transparency, enabling the inspector to precisely align features and identify differences. The inspector may toggle between side-by-side view 114 and overlay view 116 according to preference and inspection needs.

The comparative analysis module 46 may provide access to multiple historical photographs 84 from different prior inspections. The inspector may navigate through a chronological sequence of historical photographs 84 to observe progression of a condition over multiple inspections. This multi-point comparison reveals trends that might not be apparent from comparison with only the most recent prior inspection.

When the comparison reveals progressive damage or deterioration, the inspector may adjust the condition assessment 80 accordingly and document observations in notes associated with the checkpoint. The comparative analysis capability transforms inspection from a point-in-time observation into a longitudinal assessment considering the component's history and trajectory.

### VIII. Scheduling Optimization

The system 10 comprises a scheduling optimization module 48 configured to prioritize inspection checkpoints 78 based on a scheduled departure time of the aircraft 66. The scheduling optimization module 48 retrieves departure schedule 134 data from flight operations systems, FBO scheduling systems, or manual entry by the inspector.

Based on the departure schedule 134 and an estimated time to complete the full inspection, the scheduling optimization module 48 calculates whether sufficient time exists to complete all checkpoints before the scheduled departure. When available time is adequate, the inspection proceeds according to the standard checkpoint sequence. When available time is constrained, the scheduling optimization module 48 implements prioritization to ensure the most critical items are completed.

Safety-critical checkpoints are identified in the standard operating procedures 38 and are assigned high priority by the scheduling optimization module 48. Safety-critical checkpoints may include flight control surfaces, landing gear components, engine inlets and exhausts, pitot-static systems, and other items whose condition directly affects airworthiness. When time is constrained, the scheduling optimization module 48 reorders the checklist to present safety-critical checkpoints first, ensuring their completion even if the full inspection scope cannot be achieved.

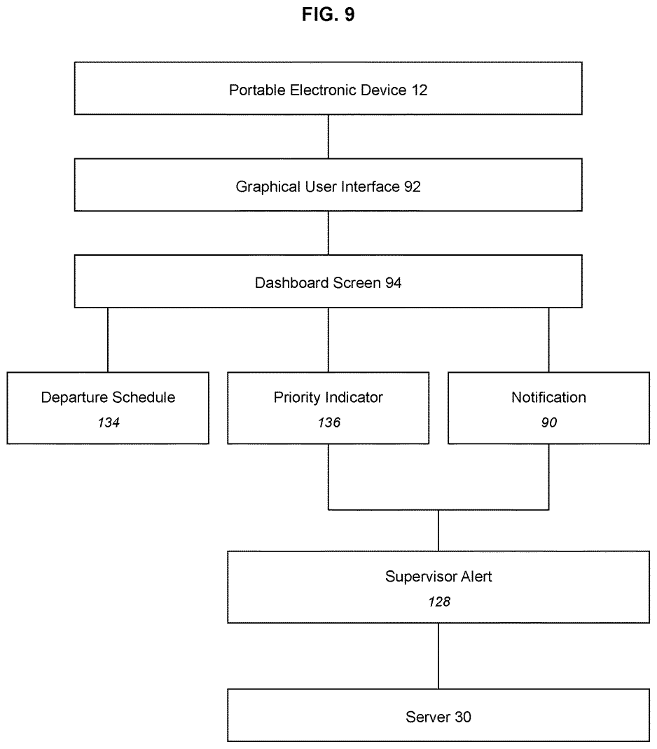

Referring also to FIG. 9, a priority indicator 136 may be displayed on the graphical user interface 92 to inform the inspector of time constraints and prioritization status. When the inspection is on track for timely completion, the priority indicator 136 displays a normal status. When time constraints require prioritization, the priority indicator 136 displays an alert status and indicates which checkpoints have been prioritized. When the inspection cannot be completed before departure, the priority indicator 136 displays a warning status and the scheduling optimization module 48 generates a supervisor alert 128.

As further illustrated in FIG. 9, the supervisor alert 128 notifies supervisory personnel that an aircraft inspection may not complete before the departure schedule 134. The alert enables supervisors to take action such as assigning additional inspectors to assist, coordinating with flight operations to delay departure, or authorizing a reduced inspection scope with appropriate documentation.

### IX. Audit and Replay

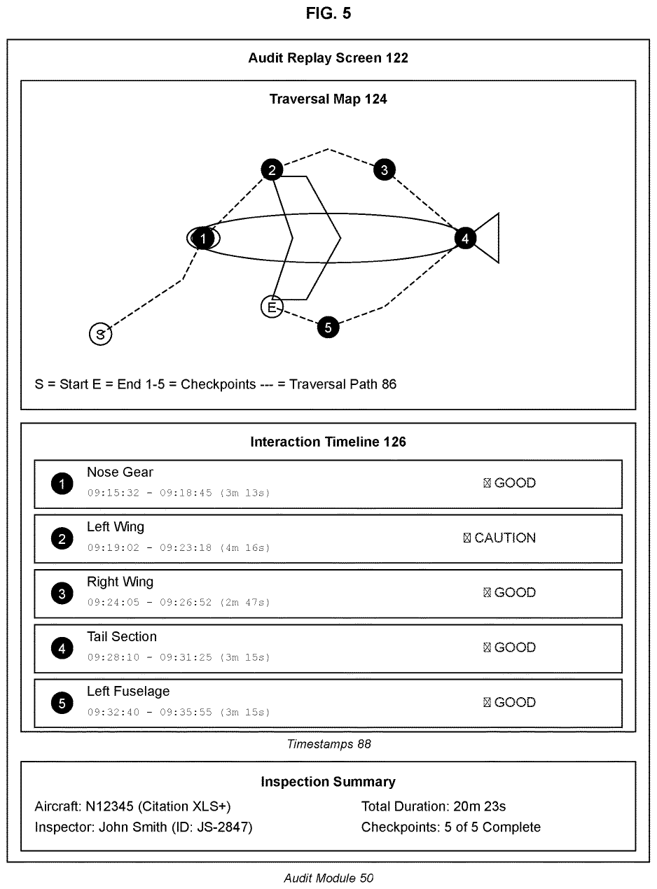

Referring now to FIG. 5, an audit timeline view illustrating inspector traversal path 86 and checkpoint interaction timestamps 88 according to an embodiment of the present invention is shown. The system 10 comprises an audit module 50 configured to record comprehensive data enabling reconstruction of how an inspection was conducted.

Throughout an inspection, the audit module 50 records a traversal path 86 of the portable electronic device 12 using GPS breadcrumb tracking. At regular intervals, the position of the device is logged, creating a continuous record of inspector movement around the aircraft 66. The traversal path 86 is stored in association with the inspection record.

The audit module 50 also logs timestamps 88 associated with each checkpoint interaction. Timestamps 88 are recorded for events including checkpoint display, checkpoint zone entry, condition assessment entry, photograph capture, audio note recording, and checkpoint completion. The timestamps 88 provide precise documentation of when each action occurred during the inspection.

The audit replay screen 122 presents the recorded data for supervisory review. A traversal map 124 displays the inspector's movement path overlaid on a diagram or aerial image of the aircraft and surrounding area. An interaction timeline 126 displays the sequence of checkpoint completions with associated timestamps 88. The supervisor can observe how the inspector moved around the aircraft and how long the inspector spent at each checkpoint.

The audit module 50 may identify and flag anomalies for supervisory attention. Anomalies may include checkpoints completed in unusually short time periods, which may indicate inadequate inspection attention; extended periods of device immobility, which may indicate the device was left unattended; movement patterns inconsistent with thorough inspection, such as skipping checkpoint zones; or timestamps inconsistent with claimed inspection activities. Flagged anomalies enable supervisors to investigate potential quality issues and address inspector performance concerns.

The audit capability supports dispute resolution when questions arise about aircraft condition or inspection performance. The detailed record of inspector location and activity provides objective evidence of what occurred during the inspection, beyond the subjective documentation provided by the inspector. This evidentiary value enhances the credibility of inspection records and strengthens FBO defenses against unwarranted claims.

### X. Additional Disclosed Features

The system 10 may further comprise a photo quality validation module 52 configured to analyze captured photographs 82 against quality criteria before acceptance. Quality criteria may include minimum lighting threshold, focus sharpness, image resolution, correct camera orientation (rear camera versus front camera), and presence of expected visual features. Photographs failing quality criteria trigger a quality validation prompt 138 (FIG. 10) informing the inspector of the deficiency and a recapture prompt 140 (FIG. 10) guiding the inspector to capture an acceptable photograph. For example, a photograph captured with insufficient lighting may trigger a prompt stating “photograph too dark-enable flash or move to better lighting.”

The system 10 may further comprise a skip justification module 54 configured to require structured justification when an inspector is unable to complete a checkpoint. As further illustrated in FIG. 10, the unable-to-complete interface 108 presents a justification selector 110 with predefined reasons including access blocked by equipment, safety hazard present, required tool unavailable, component not accessible on aircraft configuration, and an “other” option requiring accompanying text entry. Selection of an unable-to-complete status triggers automatic notification 90 (FIG. 9) to supervisory personnel, creating accountability for omitted checkpoints and preventing silent omission of inspection items.

A dual verification module 56 may require independent assessment of safety-critical checkpoints by two different authenticated inspectors. When a checkpoint is designated for dual verification, a first inspector completes the checkpoint as normal. The system 10 then assigns the same checkpoint to a second inspector who must independently assess the checkpoint without visibility to the first inspector's assessment. Upon completion by both inspectors, the dual verification module 56 compares the assessments. Matching assessments result in normal checkpoint completion. Differing assessments trigger escalation requiring supervisory resolution before final status determination.

A cross-fleet pattern detection module 58 aggregates checkpoint data across multiple aircraft of the same make and model to identify statistically significant patterns. The cross-fleet pattern detection module 58 analyzes condition assessment frequencies, caution rates, and failure rates for each checkpoint type across the fleet. When a particular checkpoint shows elevated issue rates compared to historical baselines, the module generates an alert notifying FBO management of the potential fleet-wide issue. Such pattern detection may reveal emerging maintenance trends, identify manufacturing defects affecting particular aircraft series, or indicate need for service bulletin review.

The system 10 may further comprise a trend visualization module 60 configured to display condition history for individual checkpoints. Referring also to FIG. 10, a trend indicator 118 associated with each checkpoint displays a graphical representation of recent condition assessments for that checkpoint on the specific aircraft. The trend indicator 118 may comprise a sequence of colored dots corresponding to the last several assessments (green for good, yellow for caution, red for bad), a mini bar graph, or other compact visualization. The checkpoint history display 120 (FIG. 10) provides expanded trend information upon inspector request. Trend visualization enables immediate recognition of progressive deterioration patterns without requiring manual review of historical records.

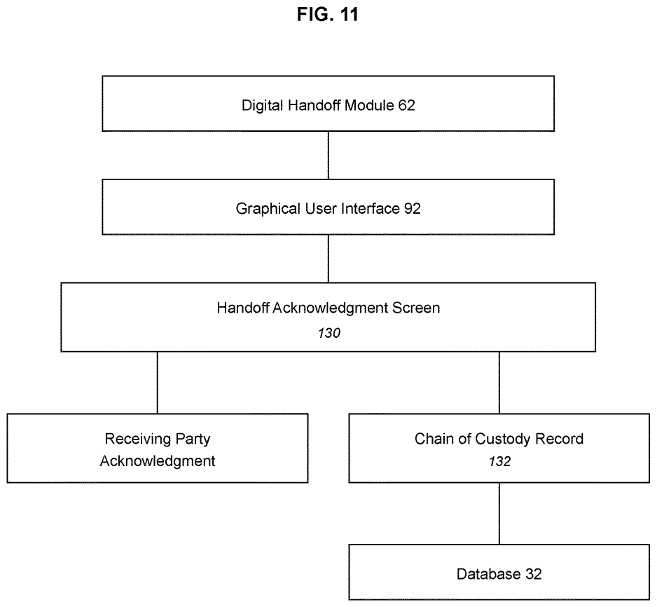

Referring also to FIG. 11, the system 10 may further comprise a digital handoff module 62 configured to create verified chain of custody records 132 as aircraft status changes between responsible parties. When an aircraft transitions between operational states—such as from inspected to fueled, from fueled to ready for departure, or from line service to maintenance—the handoff acknowledgment screen 130 (FIG. 11) requires positive acknowledgment from the receiving party. Each acknowledgment creates a timestamped chain of custody record 132 identifying the receiving party and the acknowledged status. Alerts trigger when handoffs remain pending beyond threshold time periods, preventing gaps in accountability.

A dynamic sequencing module 64 optimizes the order of inspection checkpoints 78 based on the inspector's current position. Rather than presenting checkpoints in a fixed sequence, the dynamic sequencing module 64 calculates an optimal traversal path through required checkpoints to minimize total walking distance. The calculation considers the current position of the portable electronic device 12, the positions of all remaining checkpoint zones 72, and the geometry of the aircraft 66. As the inspector completes checkpoints, the remaining sequence is dynamically reordered based on current position.

### XI. Advanced Capabilities

The system 10 may incorporate artificial intelligence modules for predictive maintenance analysis. Machine learning models trained on historical inspection data and maintenance records identify patterns predictive of component failure or maintenance needs, including correlations between flight hours, weather exposure, and historical maintenance findings. The predictive maintenance module generates recommendations for proactive maintenance based on observed conditions and predicted failure trajectories, potentially preventing in-service failures and reducing unscheduled maintenance events.

Computer vision systems may be integrated for automated damage detection and classification. Convolutional neural network models trained on images of aircraft damage analyze captured photographs 82 to identify potential damage such as scratches, dents, corrosion, cracks, delamination, or fluid leaks. The computer vision module performs baseline comparison against historical photographs 84 to detect changes, provides automatic measurement of damage extent, and generates severity scoring to assist inspector assessment. Computer vision analysis supplements inspector observation by flagging potential issues for human review, particularly subtle damage that might escape visual inspection.

Voice-activated inspection interfaces may enable hands-free operation through aviation-specific command grammar and context-aware interpretation. The inspector may speak checkpoint observations, condition assessments, and notes rather than manually entering data via touch input. Speech recognition converts spoken input to text and structured data entries, with the system interpreting commands in the context of the current checkpoint and inspection state. Voice activation is particularly valuable when inspectors need both hands free to access aircraft components or operate inspection equipment, such as when climbing ladders or working in confined spaces.

Augmented reality guidance may overlay inspection instructions on the device camera view. The augmented reality module anchors digital content to physical locations on the aircraft using aircraft-specific anchor points, highlighting checkpoint locations, displaying inspection instructions adjacent to the relevant components, and guiding inspectors through proper inspection technique. The module may employ simultaneous localization and mapping (SLAM) technology to track device position and orientation relative to the aircraft, and may visualize hidden components through the aircraft skin to indicate internal inspection points not visible from the exterior.

Blockchain-based maintenance records may provide immutable audit trails for inspection documentation. Inspection records are written to a distributed ledger that cannot be retroactively modified without detection. Smart contracts may enforce airworthiness directive compliance verification and parts authenticity validation, triggering automated alerts when compliance deadlines approach. Permissioned blockchain implementations provide data privacy while enabling authorized parties including regulatory authorities to verify record authenticity. Blockchain records offer enhanced evidentiary value by establishing that inspection documentation has not been altered since original creation.

Real-time collaboration features may enable remote expert consultation during inspections. An inspector encountering an unfamiliar condition may initiate a video call with a remote expert who can view the inspector's camera feed, provide guidance, and annotate shared images. Multiple technicians working on the same aircraft may share synchronized inspection state across their respective devices, enabling coordinated inspection activities. Real-time collaboration extends expert knowledge to field inspectors without requiring physical presence of specialists at every location.

Automated parts ordering may be triggered by identified maintenance needs. When an inspector documents a condition requiring maintenance or replacement parts, the system 10 may automatically query multiple suppliers for parts availability and pricing, generate requisition requests, and initiate purchase orders through integrated supply chain systems with configurable approval workflows. Automated ordering reduces delay between damage identification and repair initiation.

Weather-based scheduling intelligence may correlate environmental conditions with optimal inspection timing and predict weather-related wear patterns. The system 10 may recommend scheduling inspections during favorable weather windows, alert when approaching weather may affect aircraft condition, or adjust inspection scope based on weather exposure during parking. Historical correlation of weather patterns with maintenance findings enables prediction of likely inspection outcomes based on environmental exposure. Weather intelligence integration supports proactive inspection planning.

### XII. Method of Operation

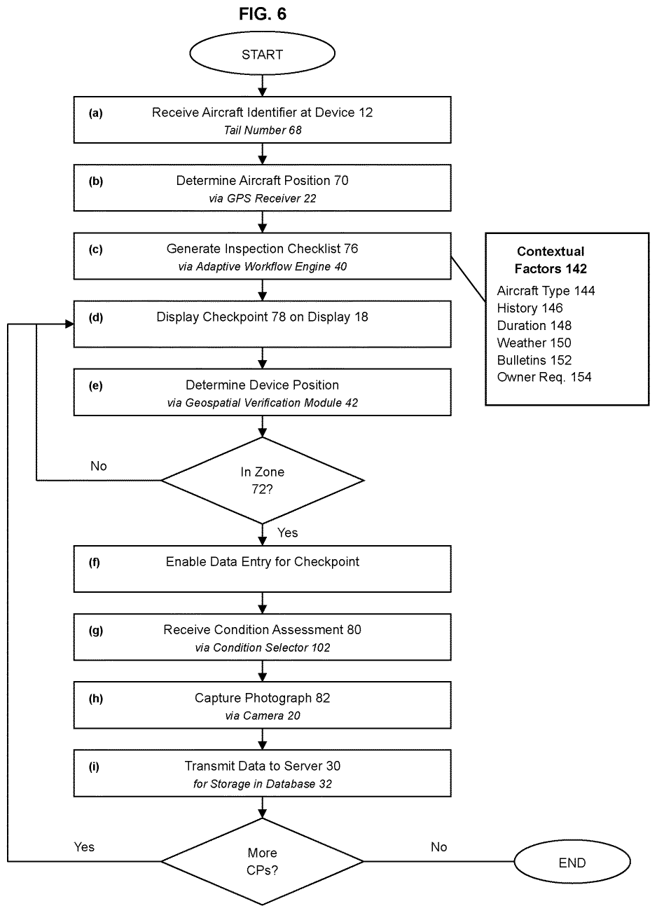

Referring now to FIG. 6, a flowchart illustrating a method of conducting fixed-base operator aviation services using a portable electronic device 12 according to an embodiment of the present invention is shown. The method begins when an inspector initiates an inspection using the portable electronic device 12.

The method comprises receiving an aircraft identifier at the portable electronic device 12. The aircraft identifier may comprise a tail number 68 entered manually by the inspector, a tail number 68 scanned from a barcode or QR code displayed on the aircraft or associated documentation, a tail number 68 selected from a list of aircraft present at the FBO, or an aircraft identifier received via wireless communication from an aircraft-mounted transponder or beacon.

The method comprises determining, via the GPS receiver 22 of the portable electronic device 12, a geographic position of the aircraft 66 corresponding to the aircraft identifier. The aircraft position 70 may be determined as described above with respect to geospatial verification.

The method comprises generating, by the adaptive workflow engine 40, an inspection checklist 76 dynamically tailored based on contextual factors 142 associated with the aircraft 66. The adaptive workflow engine 40 retrieves contextual factors 142 from the database 32 and external sources, and generates the inspection checklist 76 as described above with respect to adaptive workflow.

The method comprises displaying, on the display 18 of the portable electronic device 12, a first inspection checkpoint 78 of the inspection checklist 76. The checkpoint display screen 100 presents checkpoint identification, inspection instructions, and input controls for documenting the checkpoint.

The method comprises determining, by the geospatial verification module 42, a position of the portable electronic device 12 relative to the geographic position of the aircraft 66. The geospatial verification module 42 continuously or periodically determines device position and compares it to checkpoint zones 72 as described above.

The method comprises enabling data entry for the first inspection checkpoint 78 only when the position of the portable electronic device 12 is within a predefined proximity to the checkpoint location 74 corresponding to the first inspection checkpoint. Geospatial verification ensures the inspector has physically traveled to the checkpoint location before documenting the checkpoint.

The method comprises receiving, via the user interface 26 of the portable electronic device 12, a condition assessment 80 for the first inspection checkpoint 78. The inspector selects a condition status reflecting the observed state of the checkpoint component.

The method comprises capturing, via the camera 20 of the portable electronic device 12, a photograph 82 associated with the first inspection checkpoint 78. The photograph provides visual documentation of checkpoint condition at the time of inspection.

The method comprises transmitting the condition assessment 80 and the photograph 82 to the server 30 for storage in association with the aircraft identifier. The inspection record is synchronized to the database 32 for persistent storage, subsequent retrieval, and analytical processing.

The method may further comprise revealing subsequent inspection checkpoints 78 only after receiving condition assessments 80 and capturing photographs 82 for preceding checkpoints, implementing progressive disclosure as described above. The method may further comprise retrieving historical photographs 84 from prior inspections and displaying them for comparative assessment. The method may further comprise validating captured photographs against quality criteria and prompting recapture when criteria are not satisfied. The method may further comprise requiring structured justification for unable-to-complete selections and triggering automatic supervisory notification. The method may further comprise dynamically reordering the inspection checklist 76 based on current device position to minimize traversal distance.

### XIII. Graphical User Interface

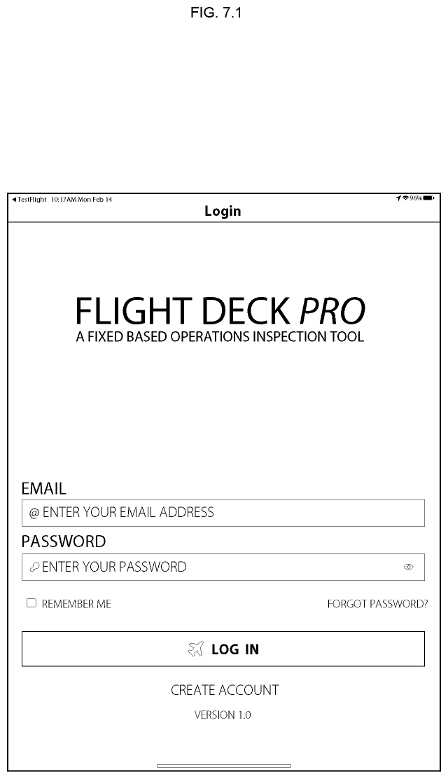

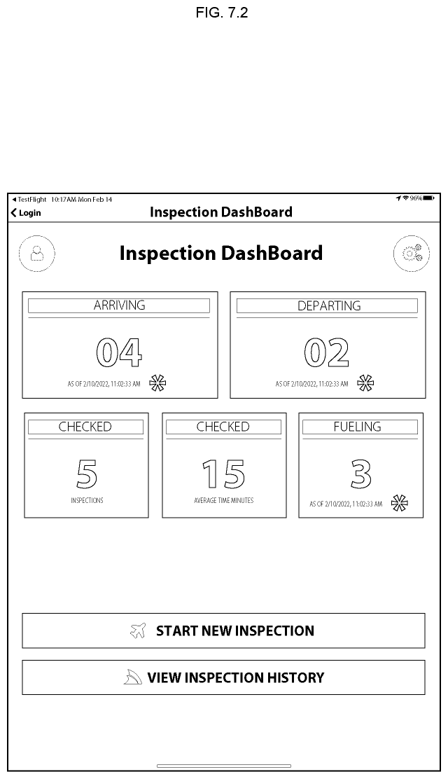

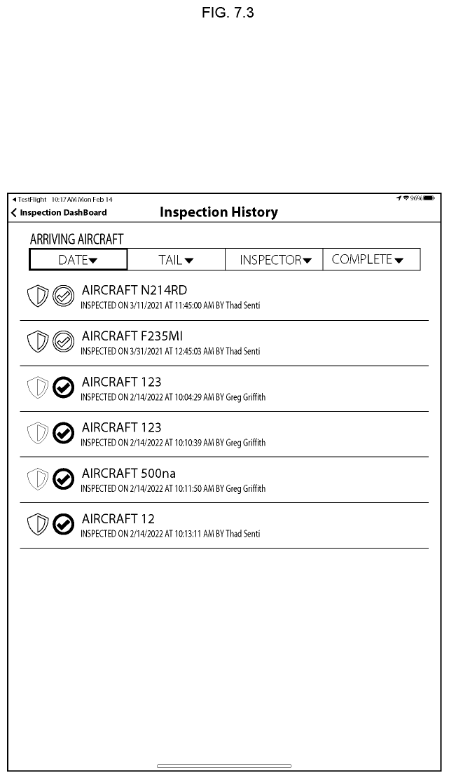

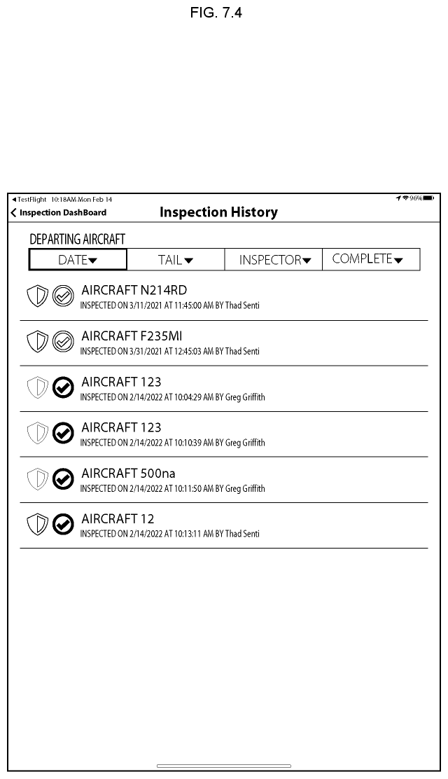

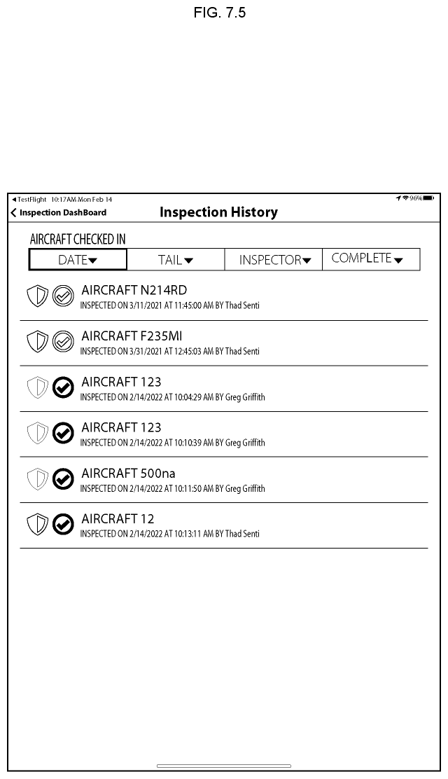

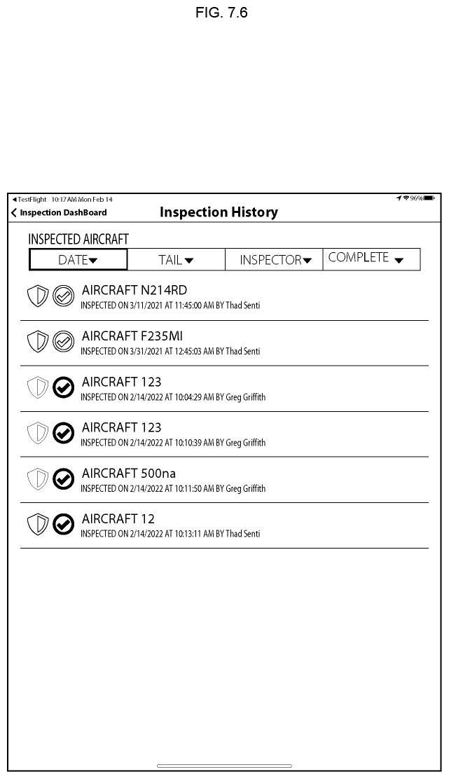

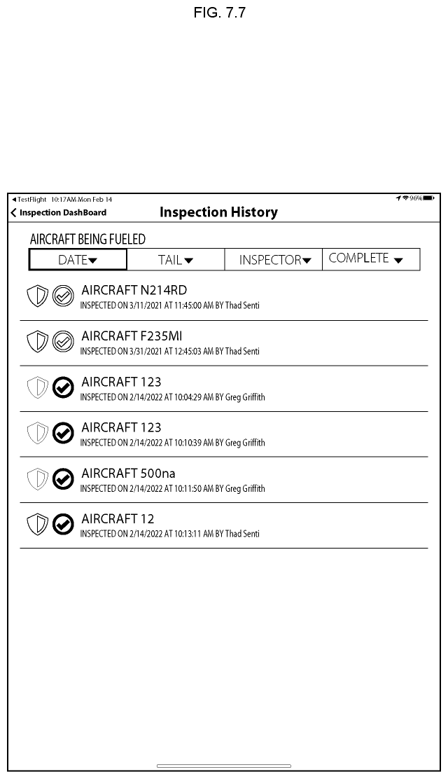

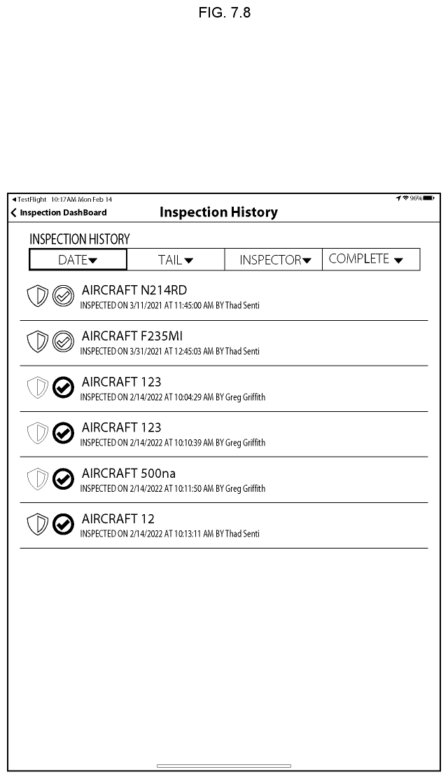

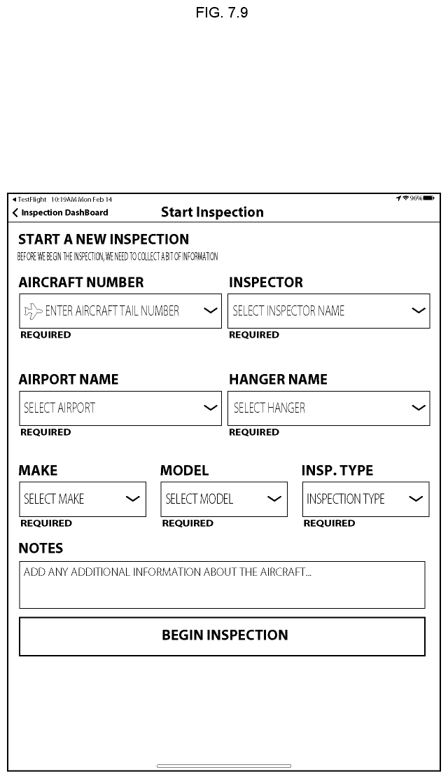

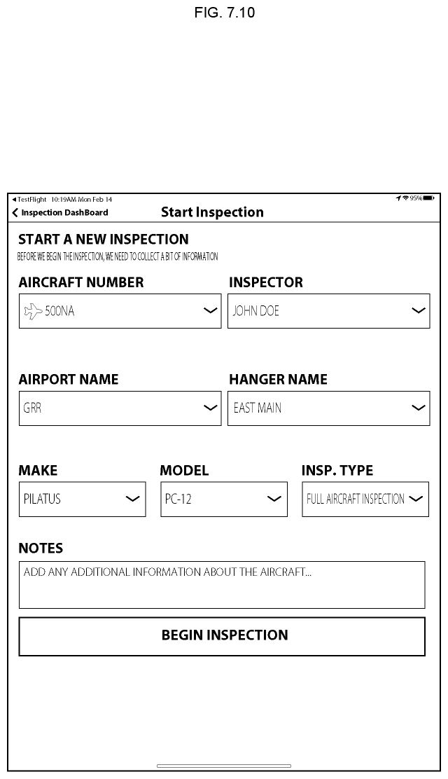

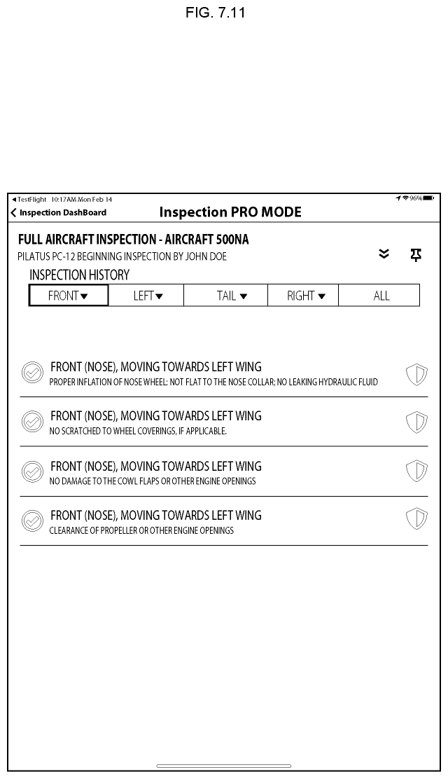

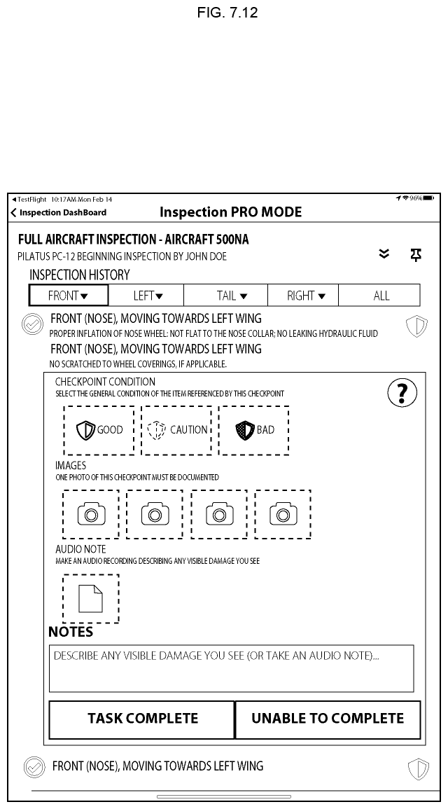

Referring now to FIGS. 7.1-7.12, representations of a graphical user interface 92 displayed on the portable electronic device 12 during an inspection workflow according to an embodiment of the present invention are shown. The graphical user interface 92 comprises multiple screens presented to the inspector during the inspection process, with additional interface components illustrated in FIGS. 9-11.

FIG. 7.1 illustrates a login screen presented upon launch of the inspection application on the portable electronic device 12. The login screen provides email and password entry fields enabling inspector authentication prior to accessing the graphical user interface 92. Authentication establishes inspector identity for association with subsequent inspection records and chain of custody documentation.

FIG. 7.2 illustrates a dashboard screen 94 (see also FIG. 9) presented following successful authentication. The dashboard screen 94 displays summary information including counts of arriving and departing aircraft, completed inspections, average inspection time, and aircraft currently being fueled. Navigation elements enable the inspector to initiate a new inspection or access inspection history records. The dashboard screen 94 serves as the primary operational overview from which the inspector manages inspection activities.

FIGS. 7.3-7.8 illustrate inspection history views presenting filtered lists of aircraft records 34. FIG. 7.3 illustrates an arriving aircraft filter displaying aircraft that have arrived at the FBO. FIG. 7.4 illustrates a departing aircraft filter displaying aircraft scheduled for departure. FIG. 7.5 illustrates an aircraft checked-in filter. FIG. 7.6 illustrates an inspected aircraft filter displaying aircraft for which inspections have been completed. FIG. 7.7 illustrates an aircraft being fueled filter. FIG. 7.8 illustrates a comprehensive inspection history view displaying all inspection records. Each inspection history view displays the aircraft tail number 68, inspection date and time, and inspector name, and enables sorting by date, tail number, inspector, and completion status.

FIG. 7.9 illustrates an inspection initiation screen 98 presenting an empty form for commencing a new inspection. The inspection initiation screen 98 includes required fields for aircraft number (tail number 68), inspector name, airport name, hangar name, aircraft make and model (corresponding to aircraft type 144), inspection type, and optional notes. The required fields ensure collection of contextual factors 142 necessary for the adaptive workflow engine 40 to generate an appropriate inspection checklist 76.

FIG. 7.10 illustrates the inspection initiation screen 98 with fields populated for a specific inspection. In the illustrated example, the aircraft number, inspector, airport, hangar, make, model, and inspection type fields have been completed, and the inspector may select “Begin Inspection” to proceed to checkpoint documentation.

FIG. 7.11 illustrates a checkpoint display screen 100 (see also FIG. 10) presenting the inspection checklist 76 in a list view. The checkpoint display screen 100 identifies the aircraft 66 under inspection and displays individual inspection checkpoints 78 organized by location around the aircraft, with selectable tabs for front, left, tail, right, and all checkpoints. Each checkpoint entry displays the checkpoint location, a description of the inspection requirement, and a completion indicator. This view enables the inspector to navigate among checkpoints during the inspection workflow.

FIG. 7.12 illustrates the checkpoint display screen 100 with a checkpoint expanded to reveal detailed inspection controls. The expanded view presents a condition selector 102 providing selectable options including “Good,” “Caution,” and “Bad” for recording the condition assessment 80. A photo capture interface 104 is displayed with placeholders for capturing one or more photographs 82 of the checkpoint. An audio note recorder 106 (see also FIG. 10) enables the inspector to record spoken observations. A notes field permits entry of written descriptions of observed conditions. The inspector may select “Task Complete” upon satisfactory documentation or “Unable to Complete” to invoke the unable-to-complete interface 108 (see also FIG. 10), which presents the justification selector 110 for recording a structured reason for incompletion.

The graphical user interface 92 screens illustrated in FIGS. 7.1-7.12 represent an embodiment of the inspection workflow as implemented on the portable electronic device 12. The screens demonstrate the progressive flow from authentication through dashboard overview, inspection history review, inspection initiation, and checkpoint-level documentation with condition assessment, photographic evidence, and audio notation capabilities.

Additional interface components of the graphical user interface 92 are illustrated in FIGS. 9-11. FIG. 9 illustrates the relationship between the dashboard screen 94 and notification 90, departure schedule 134, priority indicator 136, and supervisor alert 128 components. FIG. 10 illustrates the aircraft selection screen 96, by which the inspector may select an aircraft for inspection from among aircraft present at the FBO, the inspection initiation screen 98, and the checkpoint display screen 100, together with checkpoint interaction sub-components including the audio note recorder 106, the unable-to-complete interface 108, and the justification selector 110, and analysis and validation sub-components including the trend indicator 118, the checkpoint history display 120, the quality validation prompt 138, and the recapture prompt 140. FIG. 11 illustrates the digital handoff architecture including the handoff acknowledgment screen 130 and chain of custody record 132 generation.

The trend indicator 118 and checkpoint history display 120 illustrated in FIG. 10 provide historical context during active inspection. The trend indicator 118 displays a compact graphical representation of recent condition assessments 80 for a checkpoint on the specific aircraft 66 being inspected. The checkpoint history display 120 provides expanded historical information upon inspector request, enabling informed assessment of progressive conditions.

The quality validation prompt 138 and recapture prompt 140 illustrated in FIG. 10 ensure photographic documentation meets minimum quality standards. When a captured photograph 82 fails quality criteria assessed by the photo quality validation module 52, the quality validation prompt 138 identifies the specific deficiency and the recapture prompt 140 guides the inspector to capture an acceptable replacement photograph.

The handoff acknowledgment screen 130 and chain of custody record 132 illustrated in FIG. 11 establish verified transfers of responsibility for aircraft 66 between operational parties. The digital handoff module 62 coordinates these transfers, requiring positive acknowledgment from receiving parties and generating timestamped chain of custody records 132 stored in the database 32.

### XIV. Computing System

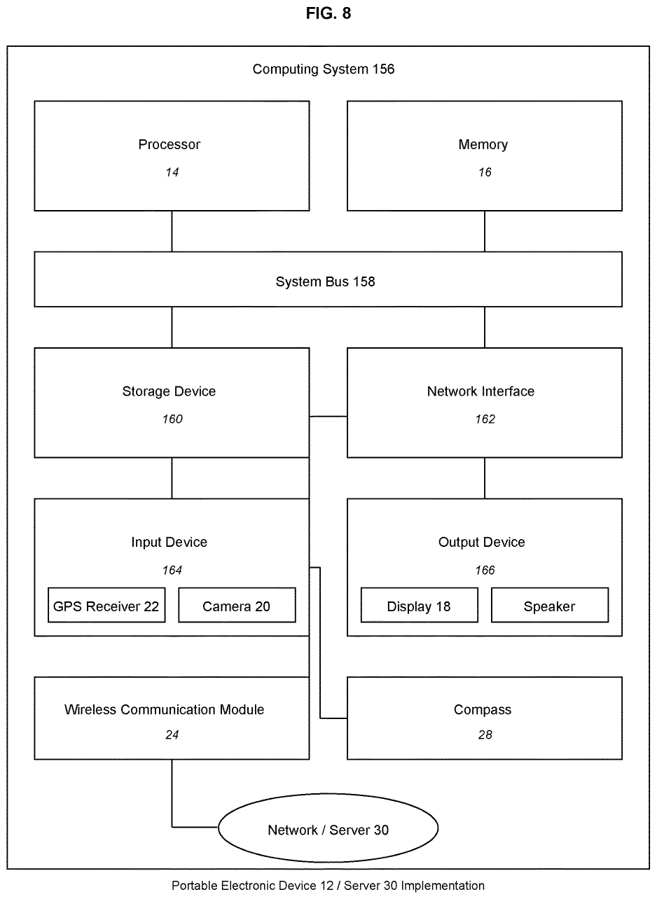

Referring now to FIG. 8, a block diagram illustrating components of a computing system 156 suitable for implementing embodiments of the present invention is shown. The computing system 156 may embody the portable electronic device 12, the server 30, or other computing components of the system 10.

The computing system 156 comprises a processor 14 in communication with a memory 16 via a system bus 158. The processor 14 may comprise one or more central processing units (CPUs), graphics processing units (GPUs), digital signal processors (DSPs), or other processing devices. The memory 16 may comprise volatile memory such as RAM and non-volatile memory such as ROM, flash memory, or solid-state storage.

Persistent data storage is provided by a storage device 160 communicatively coupled to the system bus 158. The storage device 160 may comprise hard disk drives, solid-state drives, or other mass storage devices. In server embodiments, the storage device 160 stores application software, operating system software, and data including the database 32.

A network interface 162 enables communication between the computing system 156 and other devices or networks. The network interface 162 may support wired connections such as Ethernet as well as wireless protocols including Wi-Fi, cellular, and Bluetooth.

User input is received through an input device 164 coupled to the system bus 158. In portable electronic device embodiments, the input device 164 may comprise a touch-sensitive display, physical buttons, microphone for voice input, camera for visual input, and sensors including GPS receiver 22, accelerometer, gyroscope, and compass 28. Server embodiments may employ keyboard, mouse, and network-received data as input devices.

Information is presented to users through an output device 166. In portable electronic device embodiments, the output device 166 may comprise the display 18, speaker, and haptic feedback mechanisms. Server embodiments may employ displays, network transmission, and data output interfaces for information delivery.

Instructions implementing the methods and systems described herein are stored in the memory 16 or storage device 160 and executed by the processor 14. The instructions may be embodied in software, firmware, or a combination thereof.

The illustrated embodiments depict inspection of fixed-wing aircraft; however, the present invention is equally applicable to inspection of rotary-wing aircraft, unmanned aerial vehicles, and other aircraft types. The checkpoint definitions, zone configurations, and SOP requirements may be adapted to suit various aircraft configurations.

The principles described herein extend beyond pre-flight and post-flight inspections to encompass other FBO service documentation including fueling operations, towing and repositioning operations, lavatory and water service, de-icing operations, and other ground handling activities. The adaptive workflow engine 40 may generate checklists appropriate to each service type.

While the illustrated embodiments depict a single portable electronic device 12 operated by a single inspector, multiple portable electronic devices may be employed simultaneously by multiple inspectors documenting different portions of an aircraft or different aircraft. The system 10 coordinates concurrent inspection activities and merges results into unified inspection records.

Positioning technologies are not limited to GPS. The system 10 may employ GLONASS, Galileo, BeiDou, and other global navigation satellite systems; assisted GPS; differential GPS; Wi-Fi positioning; Bluetooth beacon positioning; ultra-wideband positioning; and hybrid positioning combining multiple technologies.

### XV. Locomotion-Consistency Verification

In certain embodiments, the geospatial verification module 42 is configured to cross-validate position data reported by the GPS receiver 22 against motion data captured by inertial sensors of the portable electronic device 12, including an accelerometer and a gyroscope, to confirm that a reported position or traversal path 86 is consistent with actual pedestrian locomotion of the inspector. Software-based position falsification, in which manipulated location data is supplied to an application in place of genuine receiver output, would otherwise permit an inspector to satisfy geospatial verification requirements without physically traversing to checkpoint locations 74. Locomotion-consistency verification closes this avenue by requiring that the claimed movement of the portable electronic device 12 be corroborated by sensor evidence of the physical activity that such movement necessarily entails.

The geospatial verification module 42 derives a pedestrian dead reckoning estimate from the inertial sensors by detecting individual step events from accelerometer output, estimating stride length, and tracking heading changes from gyroscope output in combination with the compass 28. The dead reckoning estimate is compared against the reported traversal path 86 along multiple independent dimensions: the cumulative distance implied by detected step count and stride length is compared to reported displacement; the sequence and magnitude of heading changes is compared to turns in the reported path; step cadence is compared to reported velocity; and barometric pressure stability may be compared to the single-elevation character of a ramp surface. A reported transit unaccompanied by corresponding step events, or a heading history inconsistent with the geometry of the reported path, indicates falsified position data. When discrepancy between the dead reckoning estimate and the reported position exceeds a configurable threshold, the geospatial verification module 42 declines to enable data entry for the affected inspection checkpoint 78, flags the inspection record, generates a supervisor alert 128, or any combination thereof.

In certain embodiments, magnetometer data from the compass 28 provides further corroboration of physical proximity to the aircraft 66. Ferrous and ferromagnetic masses of the aircraft 66, including engines, landing gear assemblies, and actuators, produce localized distortion of the ambient magnetic field. Whereas such distortion is conventionally treated as an error source to be filtered or calibrated away, the geospatial verification module 42 employs the distortion affirmatively: detection of a magnetic anomaly gradient as the portable electronic device 12 traverses the checkpoint zones 72 corroborates that the device is moving in proximity to a large airframe rather than across an unoccupied ramp area. The observed anomaly profile may further be compared against an expected magnetic signature associated with the aircraft type 144 and stored in the aircraft records 34, with material deviation flagged for supervisory review.

In certain embodiments, accelerometer output is further analyzed to extract a gait signature of the individual carrying the portable electronic device 12, and the extracted signature is compared against an enrolled gait template associated with the authenticated inspector. Gait comparison provides identity continuity throughout the inspection, confirming that the authenticated inspector personally carried the device from checkpoint to checkpoint and defeating circumvention by credential sharing or mid-inspection transfer of the device to an unauthorized individual. Detection of a gait signature inconsistent with the enrolled template triggers a re-authentication requirement before further checkpoint completion is enabled. For checkpoints designated for verification by the dual verification module 56, comparison of gait signatures associated with the first and second assessments corroborates that the assessments were in fact performed by two different individuals.

### XVI. Photographic Liveness Verification and Dimensional Quantification

In certain embodiments, the photo capture interface 104 prompts the inspector to capture two or more photographs 82 of a checkpoint from offset positions within the checkpoint zone 72, and the photo quality validation module 52 analyzes parallax between the captured frames to verify that the photographed subject is a three-dimensional scene. Features at differing depths within a genuine three-dimensional scene exhibit depth-consistent relative displacement between frames captured from offset positions, whereas a photograph of a printed image or of a display screen, a known avenue for fabricating inspection documentation, exhibits the uniform displacement characteristic of a planar subject. Inter-frame displacement of the portable electronic device 12 may be estimated from the inertial sensors to inform the parallax analysis. A capture failing liveness verification triggers the quality validation prompt 138 identifying the deficiency and the recapture prompt 140 directing a compliant recapture. Liveness verification may be required for all checkpoints or selectively for checkpoints designated safety-critical in the standard operating procedures 38.

In certain embodiments, the system 10 performs dimensional quantification of conditions documented in captured photographs 82 by photogrammetric scaling against reference features of known dimension visible within the frame. Because the aircraft type 144 is known from the aircraft records 34, the dimensions of standard features of that aircraft type, including rivet pitch, static port diameter, door and handle geometry, and placard dimensions, are known to the system 10 and may be stored in the aircraft records 34 or the standard operating procedures 38. Registration markings provide a particularly advantageous reference feature, as the minimum display height of registration marks is prescribed by federal regulation (see, e.g., 14 C.F.R. § 45.29), such that a regulatorily mandated dimension serves as an in-frame calibration reference. By scaling against one or more reference features, the system 10 computes dimensional measurements of documented conditions, including the length of a scratch, the diameter of a dent, or the extent of a corrosion patch, in standard units together with an estimated tolerance.

Dimensional measurements are stored with the inspection records 36 and enable quantitative rather than subjective comparison across inspections. The comparative analysis module 46 may annotate the historical photograph 84 and the current view with computed dimensional change, the trend indicator 118 may present measured progression of a condition across recent inspections, and the checkpoint history display 120 may present measured values over time. Configurable thresholds applied to measured change may automatically recommend adjustment of the condition assessment 80, require supervisory review, or trigger escalation, such that a condition exhibiting measured growth between inspections is escalated on the basis of computed measurement rather than inspector estimation. Quantified measurement materially enhances the evidentiary value of inspection records in disputes concerning when damage arose and at what rate it progressed.

In certain embodiments, the offset captures employed for liveness verification additionally serve as a stereo pair from which depth-based measurement is computed by photogrammetry, the baseline separation between capture positions being estimated from the inertial sensors. Liveness verification and dimensional quantification may be employed independently or in combination, and the adaptive workflow engine 40 may require the combination for designated checkpoints.

### XVII. Composite Presence-Confidence Scoring

GPS position accuracy on an airport ramp is frequently degraded by multipath reflection from hangar structures, terminal buildings, and large aircraft, and a fixed-radius binary zone test may produce false rejections in degraded-signal conditions or false acceptances where reported accuracy is overstated. In certain embodiments, the geospatial verification module 42 therefore determines checkpoint enablement not by a binary geometric test but by computing a composite presence-confidence score from a plurality of independent evidence sources and comparing the composite score against a required threshold.

Evidence sources contributing to the composite score may include: GPS position weighted by real-time accuracy estimates including dilution-of-precision values; signal strength measurements from Bluetooth beacons positioned about the ramp, hangar, or aircraft; Wi-Fi positioning data; magnetic anomaly corroboration as described above; satisfaction of a minimum dwell time within the checkpoint zone 72; detection by the inertial sensors of an inspection gesture, such as the raise-and-hold motion characteristic of deliberate photographic framing via the photo capture interface 104, distinguishing a genuine stop-and-inspect interaction from an in-passing entry; and, in embodiments employing multiple portable electronic devices 12 operated by multiple inspectors as described above, peer attestation in which short-range ranging between devices corroborates the reported position of one device by reference to another. Each evidence source is assigned a weight reflecting its reliability under current conditions, and the weighted contributions are combined into the composite presence-confidence score.

The geospatial verification module 42 adaptively varies verification stringency to maintain aggregate confidence in the presence determination notwithstanding variation in the quality of individual evidence sources. When GPS quality degrades, the geospatial verification module 42 may relax the geometric tolerance applied to the checkpoint zone 72 while increasing the corroboration required from remaining sources, for example by requiring beacon confirmation, extended dwell time, or detection of the inspection gesture, such that the composite score required for enablement is maintained. Conversely, when GPS quality is high, corroboration requirements may be reduced. Verification stringency thus adapts inversely to positioning signal quality, holding the evidentiary confidence of the resulting inspection record substantially constant across operating conditions rather than allowing record reliability to fluctuate with the signal environment.

The required composite score may vary with checkpoint designation, with checkpoints designated safety-critical in the standard operating procedures 38 requiring a higher presence-confidence score than general observation checkpoints. The achieved composite score and the contribution of each evidence source are recorded by the audit module 50 together with the timestamps 88 for each checkpoint completion, such that every inspection record carries a quantified statement of the verification confidence under which it was created, reviewable on the audit replay screen 122 and available in dispute resolution.

It will be understood that the embodiments described herein are merely exemplary and that various modifications may be made thereto without departing from the spirit and scope of the invention. The invention encompasses all modifications and variations that fall within the scope of the appended claims.

Unless otherwise indicated, all numbers expressing quantities, parameters, and measurements used in the specification and claims are to be understood as being modified in all instances by the term “approximately.” Accordingly, unless indicated to the contrary, the numerical parameters set forth in the specification and claims are approximations that may vary depending upon the desired properties sought to be obtained by the present invention.

Notwithstanding that the numerical ranges and parameters setting forth the broad scope of the invention are approximations, the numerical values set forth in specific examples are reported as precisely as possible. Any numerical value, however, inherently contains certain errors necessarily resulting from the standard deviation found in their respective testing measurements.

As used herein, the term “comprising” means including but not limited to, and should be interpreted in the manner it is typically used in the patent context. The phrases “in one embodiment,” “in certain embodiments,” “in various embodiments,” and similar phrases indicate that a particular feature, structure, or characteristic described in connection with the embodiment is included in at least one embodiment of the present invention. Such phrases do not necessarily refer to the same embodiment.

As used herein, any Markush groups are to be interpreted in accordance with their standard patent usage. Thus, a Markush group comprising a, b, and c shall be interpreted to include all of: a alone; b alone; c alone; a and b; a and c; b and c; and a, b, and c.

As used herein, ranges stated herein include the endpoints and all values within the stated range. Furthermore, the disclosure of a range includes disclosure of all subranges within the stated range, including the endpoints.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

All patents, patent applications, and publications cited herein are incorporated by reference in their entirety for all purposes.

The foregoing description of various embodiments of the invention has been presented for purposes of illustration and description. It is not intended to be exhaustive or to limit the invention to the precise form disclosed. Obvious modifications or variations are possible in light of the above teachings. The embodiments discussed were chosen and described to best illustrate the principles of the invention and its practical application to thereby enable one of ordinary skill in the art to best utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

Other embodiments are set forth in the following claims.

What is claimed and desired to be secured by Letters Patent of the United States is:

1. An adaptive system for conducting fixed-base operator aviation services, comprising:
a portable electronic device comprising a processor, a memory, a display, a camera, a GPS receiver, and a wireless communication module;
a server in wireless communication with the portable electronic device, the server comprising a database storing aircraft records, inspection records, and standard operating procedures;
an adaptive workflow engine executing on at least one of the portable electronic device and the server, the adaptive workflow engine configured to dynamically generate an inspection checklist based on contextual factors associated with an aircraft to be inspected; and
a geospatial verification module configured to determine a position of the portable electronic device relative to a position of the aircraft and to selectively enable completion of inspection checkpoints based on the determined position.

2. The system according to claim 1, wherein the geospatial verification module is configured to define a plurality of checkpoint zones corresponding to physical locations around the aircraft, and wherein the geospatial verification module enables completion of a checkpoint only when the portable electronic device is positioned within the checkpoint zone corresponding to that checkpoint.

3. The system according to claim 1, further comprising a progressive disclosure module configured to sequentially reveal inspection checkpoints on the display, wherein a subsequent checkpoint is revealed only upon completion of a preceding checkpoint, completion requiring at least a condition assessment and a captured photograph.

4. The system according to claim 1, wherein the adaptive workflow engine is configured to generate the inspection checklist based on at least one of: aircraft type, aircraft inspection history, parking duration, weather conditions during parking, applicable service bulletins, or owner-specific requirements.

5. The system according to claim 1, further comprising a comparative analysis module configured to retrieve a historical photograph of a checkpoint from a prior inspection of the same aircraft and to display the historical photograph adjacent to a current camera view during inspection of that checkpoint.

6. The system according to claim 1, further comprising a scheduling optimization module configured to prioritize inspection checkpoints based on a scheduled departure time of the aircraft, wherein safety-critical checkpoints are prioritized when a time remaining before the scheduled departure time falls below a threshold.

7. The system according to claim 1, further comprising an audit module configured to record a traversal path of the portable electronic device during inspection and to log timestamps associated with each checkpoint interaction, the audit module enabling reconstruction of the inspection sequence for supervisory review.

8. A method of conducting fixed-base operator aviation services using a portable electronic device, comprising the steps of:
receiving an aircraft identifier at the portable electronic device;
determining, via a GPS receiver of the portable electronic device, a geographic position of an aircraft corresponding to the aircraft identifier;
generating, by an adaptive workflow engine, an inspection checklist dynamically tailored based on contextual factors associated with the aircraft;
displaying, on a display of the portable electronic device, a first inspection checkpoint of the inspection checklist;
determining, by a geospatial verification module, a position of the portable electronic device relative to the geographic position of the aircraft;
enabling data entry for the first inspection checkpoint only when the position of the portable electronic device is within a predefined proximity to a checkpoint location corresponding to the first inspection checkpoint;
receiving, via a user interface of the portable electronic device, a condition assessment for the first inspection checkpoint;
capturing, via a camera of the portable electronic device, a photograph associated with the first inspection checkpoint; and
transmitting the condition assessment and the photograph to a server for storage in association with the aircraft identifier.

9. The method according to claim 8, further comprising the step of revealing a second inspection checkpoint on the display only after receiving the condition assessment and capturing the photograph for the first inspection checkpoint.

10. The method according to claim 8, wherein the step of generating the inspection checklist comprises retrieving at least one of weather data, aircraft inspection history, parking duration, or service bulletin applicability, and modifying checkpoint content based on the retrieved data.

11. The method according to claim 8, further comprising the steps of:
retrieving a historical photograph of the first inspection checkpoint from a prior inspection of the aircraft; and
displaying the historical photograph on the display simultaneously with a live camera view to enable comparative assessment.

12. The method according to claim 8, further comprising the step of validating the photograph against quality criteria including at least one of minimum lighting threshold, focus sharpness, or presence of expected checkpoint features, and prompting recapture when the quality criteria are not satisfied.

13. The method according to claim 8, further comprising the steps of:
receiving a selection of an unable-to-complete status for an inspection checkpoint;
displaying a structured justification interface requiring selection of a predefined reason for incompletion; and
transmitting an automatic notification to supervisory personnel upon receipt of the unable-to-complete status.

14. The method according to claim 8, further comprising the step of dynamically reordering the inspection checklist based on a current position of the portable electronic device relative to the aircraft to minimize traversal distance between checkpoints.

15. A non-transitory computer-readable medium storing instructions that, when executed by a processor of a portable electronic device, cause the portable electronic device to perform operations comprising:
receiving an aircraft identifier;
determining a geographic position of an aircraft corresponding to the aircraft identifier;
generating an adaptive inspection checklist based on contextual factors associated with the aircraft;
displaying inspection checkpoints on a display of the portable electronic device;
determining a position of the portable electronic device relative to the aircraft;
selectively enabling checkpoint completion based on the determined position satisfying a geospatial proximity requirement;
receiving condition assessments and capturing photographs for enabled checkpoints; and
transmitting inspection data to a remote server for storage.

16. The non-transitory computer-readable medium according to claim 15, wherein the operations further comprise sequentially revealing checkpoints such that a subsequent checkpoint is displayed only upon completion of a preceding checkpoint.

17. The non-transitory computer-readable medium according to claim 15, wherein the operations further comprise retrieving and displaying a historical photograph from a prior inspection of the same aircraft for comparative assessment during a current inspection.

18. The non-transitory computer-readable medium according to claim 15, wherein the contextual factors comprise at least one of aircraft type, prior inspection findings, elapsed time since last inspection, weather exposure during parking, or applicable service bulletins.

19. The non-transitory computer-readable medium according to claim 15, wherein the operations further comprise recording a GPS breadcrumb trail of device movement during inspection and storing checkpoint interaction timestamps to enable audit reconstruction.

20. The non-transitory computer-readable medium according to claim 15, wherein the operations further comprise prioritizing safety-critical checkpoints when a scheduled departure time of the aircraft is within a threshold period.
